(19) United States
(12) Patent Application Publication
(10) Pub. No.: US 2016/0234302 A1
(43) Pub. Date: Aug. 11, 2016

(54) METHOD, DEVICE AND SYSTEM FOR DISTRIBUTING VIRTUAL ITEMS

(71) Applicant: TENCENT TECHNOLOGY (SHENZHEN) COMPANY LIMITED, Shenzhen (CN)

(72) Inventors: Yi Wu, Shenzhen (CN); Chen Gong, Shenzhen (CN); Yongxin He, Shenzhen (CN); Yaya Liu, Shenzhen (CN); Chi Zhang, Shenzhen (CN); Shangyan Chen, Shenzhen (CN); Wei Zou, Shenzhen (CN); Jun Liang, Shenzhen (CN); Jiaxi Xu, Shenzhen (CN); Chaojun Chen, Shenzhen (CN); Jieping Chen, Shenzhen (CN); Dongdong Xie, Shenzhen (CN)

(21) Appl. No.: 15/091,612

(22) Filed: Apr. 6, 2016

Related U.S. Application Data
(63) Continuation of application No. PCT/CN2015/070197, filed on Jan. 6, 2015.

(30) Foreign Application Priority Data
Jan. 29, 2014 (CN) 201410043851.4

(51) Int. Cl. H04L 29/08

(52) U.S. Cl. CPC H04L 67/1076; H04L 67/06

(57) ABSTRACT

A method for distributing virtual items includes receiving, from a sender client device, a request for distributing virtual items to a set of recipient client devices. The method includes transferring a total amount of virtual items from an account associated with the sender client device to an account associated with a server device, and defining virtual item packages that include the total amount of virtual items transferred. The method includes sending information of the virtual item packages to the sender client device whereby the sender client device generates and sends a link associated with the distribution of virtual items to the set of recipient client devices. The method also includes receiving, from a recipient client device, a request to receive virtual items. The method further includes transferring a virtual item package from the account associated with the server device to an account associated with the recipient client device.

### RELATED APPLICATION

This application is a continuation application of International Patent Application No. PCT/CN2015/070197, filed on Jan. 6, 2015, which claims priority to Chinese Patent Application Serial No. 201410043851.4, entitled “Method, Device and System for Transmitting and Receiving Virtual Items”, filed Jan. 29, 2014, which are incorporated herein by reference in their entirety.

### TECHNICAL FIELD

The present application generally relates to the field of Internet technologies, and more particularly to a method and related device and system for distributing virtual items.

### BACKGROUND

With the rapid development of Internet technologies, various types of virtual items have emerged and been widely used, such as virtual supplies, virtual pets and virtual currency used in online gaming. Some known applications enable a user to send virtual items (e.g., cakes, greeting cards, monetary gifts, etc.) to her friends. According to such known applications, a user is typically requested to identify a recipient (e.g., a friend or contact of the user in an online community, social media, instant messenger, etc.), generate a virtual item package (e.g., a “red envelope”) containing the virtual items to be sent, and then send the virtual item package to the recipient. Such a method, however, typically requires a user to send virtual items to one recipient at a time. As a result, a user needs to repeat the operations if she intends to send virtual items to a large number of recipients, which can be complicated, burdensome, and time consuming. Also, it might be difficult for a user to distribute virtual items if she is not able to accurately identify the recipient(s).

Thus, a need exists for a method, device and system that can enable users to distribute virtual items in an efficient manner when multiple recipients are targeted and/or a recipient is not accurately identified.

### SUMMARY

The above deficiencies associated with the known applications and method for distributing virtual items may be reduced or eliminated by the techniques described herein.

In some embodiments, a method for distributing virtual items at a server device is performed at a computer system having one or more processors and memory for storing programs to be executed by the one or more processors. The method includes receiving, from a sender client device, a request for distributing virtual items to a set of recipient client devices. The request includes parameters associated with the distribution of virtual items. In some instances, the parameters associated with the distribution of virtual items include, for example, the total amount of virtual items to be distributed, a total number of virtual item packages, an amount of virtual items associated with each virtual item package, and/or the like. In some instances, a user of each recipient client device from the set of recipient client devices has a social relationship with a user of the sender client device.

The method includes transferring, in response to the request for distributing virtual items, a total amount of virtual items to be distributed from an account associated with the sender client device to an account associated with the server device. The method includes defining, based on the parameters associated with the distribution of virtual items, a group of virtual item packages. Each virtual item package from the group of virtual item packages includes at least one virtual item to be distributed. The total amount of virtual items included in the group of virtual item packages corresponds to the total amount of virtual items transferred from the account associated with the sender client device to the account associated with the server device. In some instances, the defining includes randomly assigning virtual items to each virtual item package from the group of virtual item packages in accordance with the parameters associated with the distribution of virtual items.

The method includes sending information of the group of virtual item packages to the sender client device whereby the sender client device generates a link associated with the distribution of virtual items and sends the link to the set of recipient client devices. In some instances, the method also includes, before sending information of the group of virtual item packages to the sender client device, generating an identifier for the group of virtual item packages. In such instances, the information of the group of virtual item packages sent to the sender client device includes the identifier for the group of virtual item packages.

The method includes subsequently receiving, from a recipient client device from the set of recipient client devices, a request to receive virtual items. In some instances, the method also includes receiving identifiers of each recipient client device from the set of recipient client devices such that the server device stores and associates the identifiers of the set of recipient client devices with the group of virtual item packages.

The method further includes transferring, in response to the request to receive virtual items, a virtual item package from the group of virtual item package from the account associated with the server device to an account associated with the recipient client device. In some instances, the transferring includes randomly selecting the virtual item package from a subgroup of virtual item packages that have not been transferred from the account associated with the server device to any account associated with any recipient client device from the set of recipient client devices.

Additionally, in some instances, the method includes, after receiving the request to receive virtual items and before transferring the virtual item package to the account associated with the recipient client device, determining if the recipient client device satisfies a predefined condition for receiving the virtual items. Furthermore, in some instances, such a predefined condition includes that a user of the recipient client device has a predefined social relationship with a user of the sender client device.

In some embodiments, a server device configured to distribute virtual items is disclosed. The server device includes one or more processors and memory storing one or more programs for execution by the one or more processors. The one or more programs include instructions that cause the server device to perform the method for distributing virtual items as described above. In some embodiments, a non-transitory computer readable storage medium is disclosed. The non-transitory computer readable storage medium stores one or more programs including instructions for execution by one or more processors. The instructions, when executed by the one or more processors, cause the processors to perform the method for distributing virtual items as described above.

Various advantages of the present application are apparent in light of the descriptions below.

### BRIEF DESCRIPTION OF THE DRAWINGS

The aforementioned features and advantages of the present application as well as additional features and advantages thereof will be more clearly understood hereinafter as a result of a detailed description of preferred embodiments when taken in conjunction with the drawings.

FIG. 1 is a schematic diagram illustrating a system configured to distribute virtual items in accordance with some embodiments.

FIG. 2 is a flowchart illustrating a method performed at a sender client device for distributing virtual items in accordance with some embodiments.

FIG. 3 is a flowchart illustrating a method performed at a server device for distributing virtual items in accordance with some embodiments.

FIG. 4 is a flowchart illustrating a method performed at a recipient client device for distributing virtual items in accordance with some embodiments.

FIG. 5A is a flowchart illustrating a method performed at a sender client device, a server device and a recipient client device for distributing virtual items in accordance with some embodiments.

FIGS. 5B-5D are schematic diagrams illustrating user interfaces of the client devices associated with performing the method of FIG. 5A.

FIG. 6 is a flowchart illustrating another method performed at a sender client device, a server device and a recipient client device for distributing virtual items in accordance with some embodiments.

FIG. 7 is a block diagram illustrating components of a sender client device in accordance with some embodiments.

FIG. 8 is a block diagram illustrating components of a server device in accordance with some embodiments.

FIG. 9 is a block diagram illustrating components of a recipient client device in accordance with some embodiments.

FIG. 10 is a block diagram illustrating components of the sender client device, the server device, and the recipient client device of FIGS. 7-9.

FIG. 11 is a block diagram illustrating components of a client device in accordance with some embodiments.

FIG. 12 is a block diagram illustrating components of a server device in accordance with some embodiments.

FIG. 13 is a schematic diagram illustrating a system consisting of a sender client device, a server device and a recipient client device in accordance with some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

In order to make the objectives, technical solutions, and advantages of the present application comprehensible, embodiments of the present application are further described in detail below with reference to the accompanying drawings.

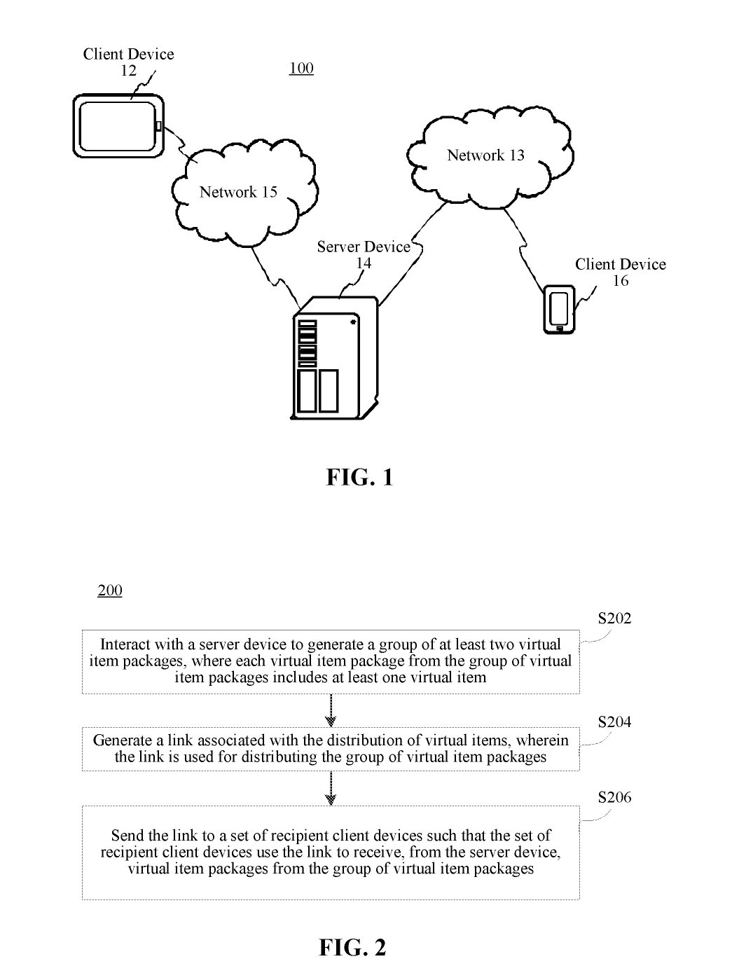

FIG. 1 is a schematic diagram illustrating a system 100 configured to distribute virtual items in accordance with some embodiments. As shown in FIG. 1, the system 100 includes a server device 14 and client devices 12, 16. The server device 14 is operatively coupled to and communicates with the client devices 12, 16 via networks 15 and 13, respectively. Although not shown in FIG. 1, the client device 12 or 16 can be accessed and operated by one or more users. The server device 14 and the client devices operatively coupled to the server device 14 (e.g., the client devices 12, 16) are configured to collectively distribute virtual items among a set of client devices as described herein.

Although shown in FIG. 1 as including a single server device and two client devices, in other embodiments, a system configured to distribute virtual items can include any number of server devices and/or any number of client devices. Each server device included in such a system can be identical or similar to the server device 14, and each client device included in such a system can be identical or similar to the client devices 12, 16. For example, more than two client devices can be operatively coupled to and communicate with a server device to receive virtual items. For another example, a client device can be operatively coupled to and communicate with a first server device to distribute virtual items to other client devices via a first Internet application (e.g., an online gaming application), and can be operatively coupled to and communicate with a second server device to distribute virtual items to other client devices via a second Internet application (e.g., an instant messaging application).

The networks 13, 15 can be any type of network configured to operatively couple one or more server devices (e.g., the server device 14) to one or more client devices (e.g., the client device 125), and enable communications between the server device(s) and the client device(s). In some embodiments, each of the networks 13, 15 can include one or more networks such as, for example, a cellular network, a satellite network, a local area network (LAN), a wide area network (WAN), a wireless local area network (WLAN), the Internet, etc. Furthermore, the networks 13, 15 can be optionally implemented using any known network protocol including various wired and/or wireless protocols such as, for example, Ethernet, universal serial bus (USB), global system for mobile communications (GSM), enhanced data GSM environment (EDGE), general packet radio service (GPRS), long term evolution (LTE), code division multiple access (CDMA), wideband code division multiple Access (WCDMA), time division multiple access (TDMA), Bluetooth, Wi-Fi, voice over internet protocol (VoIP), Wi-MAX, etc.

The server device 14 can be any type of device configured to function as a server-side device of the system 100. Specifically, the server device 14 is configured to communicate with one or more client devices (e.g., the client devices 12, 16) via one or more networks (e.g., the networks 13, 15), and provide a service associated with distributing virtual items to user(s) of the client device(s). In some embodiments, the server device 14 can be, for example, a background server, a back end server, a database server, a workstation, a desktop computer, a cloud computing server, a data processing server, and/or the like. In some embodiments, the server device 14 can be a server cluster, a cloud computing center, a data center, or a server center consisting of two or more devices (e.g., a data processing server, a computing server, a database server, etc.). Details of a server device are further shown and described with respect to FIGS. 8, 10 and 12.

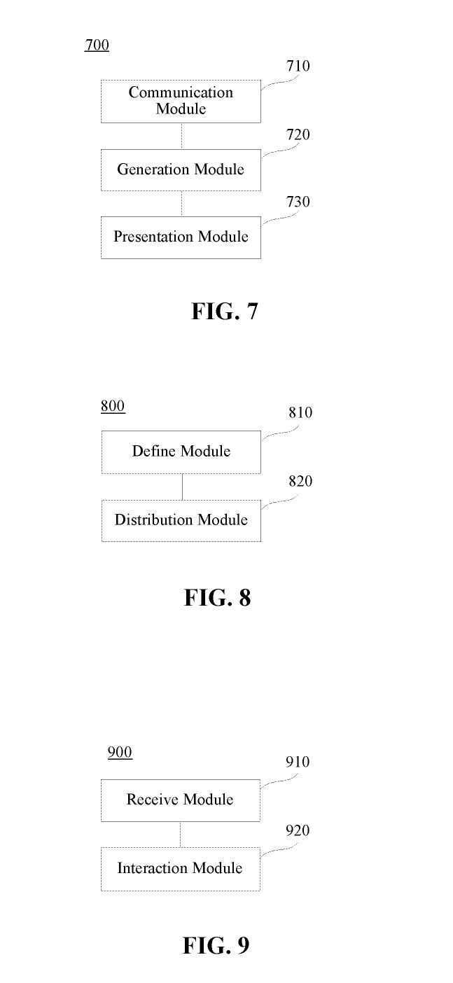

The client devices 12, 16 can be any type of electronic devices configured to function as a client-side device of the system 100. Specifically, each of the client devices 12, 16 is configured to communicate with one or more server device(s) (e.g., the server device 14) via one or more networks (e.g., the networks 13, 15), and interact with one or more users operating the client device 12 or 16 to provide the service associated with distributing virtual items to the user(s). In some embodiments, the client devices 12, 16 can be, for example, a cellular phone, a smart phone, a mobile Internet device (MID), a personal digital assistant (PDA), a touchpad, a tablet computer, an e-book reader, a laptop computer, a handheld computer, a desktop computer, a wearable device, a MP3 (Moving Picture Experts Group Audio Layer III) player, a MP4 (Moving Picture Experts Group Audio Layer IV) player, and/or any other personal electronic device. In some embodiments, a client device can also be referred to as, for example, a mobile device, a user device, a terminal, a portable device, and/or the like. Details of an example of a client device are further shown and described with respect to FIGS. 7, and 9-11.

In some embodiments, a client device (e.g., the client device 12 or 16) included in the system 100 is configured to function as a sender client device, a recipient client device, or both a sender client device and a recipient client device. As described in detail below, a sender client device is configured to initiate a process of distributing virtual items to a set of one or more recipient client devices that are targeted by the sender client device. Such a sender client device typically implements a sender-client-portion of an application (e.g., an online gaming application, a social networking application, an instant messaging application, etc.) including a sending interface that is configured to enable a user of the sender client device to distribute virtual items associated with the application. Correspondingly, a recipient client device is configured to receive virtual items distributed by a sender client device. Such a recipient client device typically implements a recipient-client-portion of an application (e.g., an online gaming application, a social networking application, an instant messaging application, etc.) including a receiving interface that is configured to enable a user of the recipient client device to receive virtual items associated with the application.

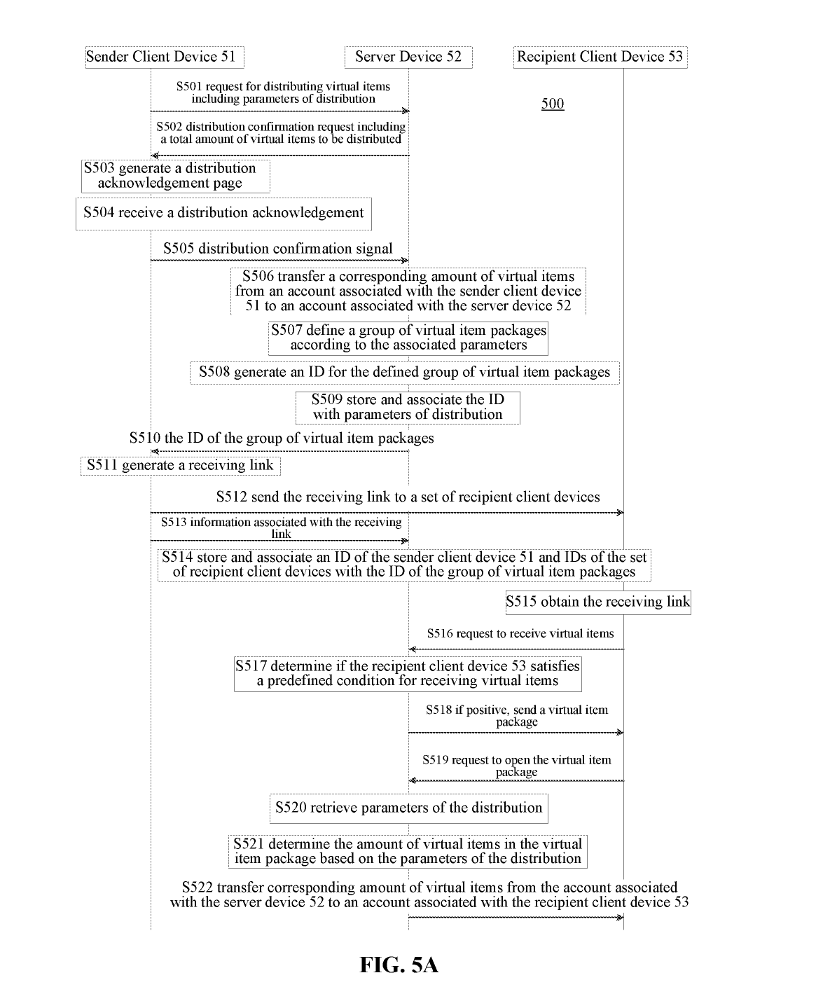

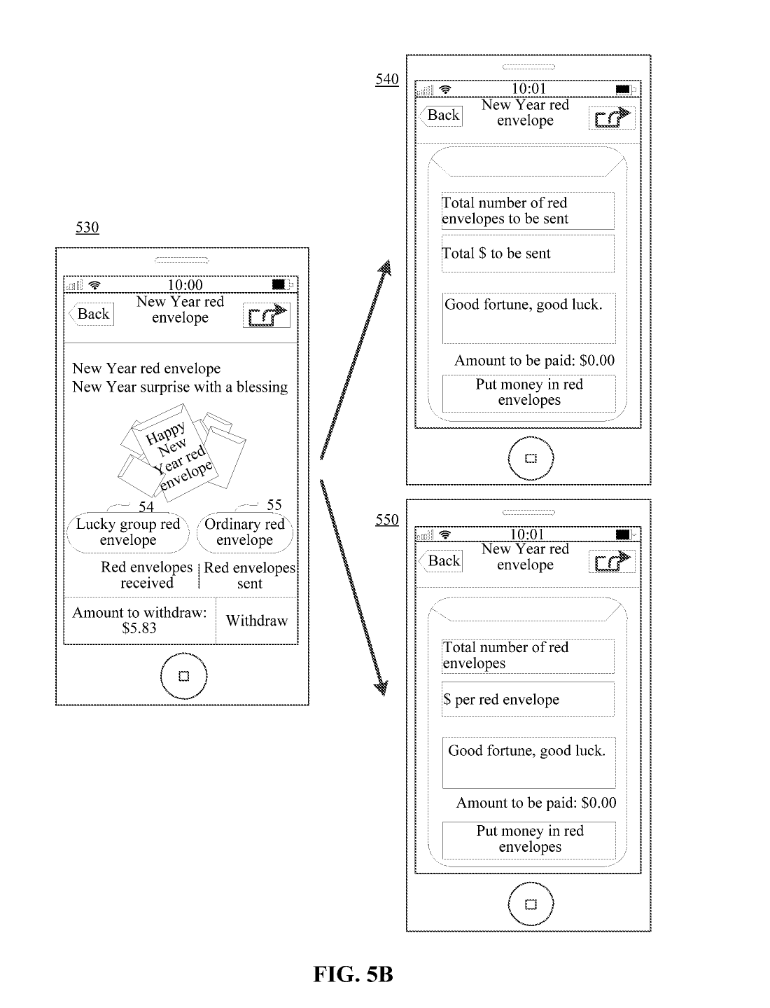

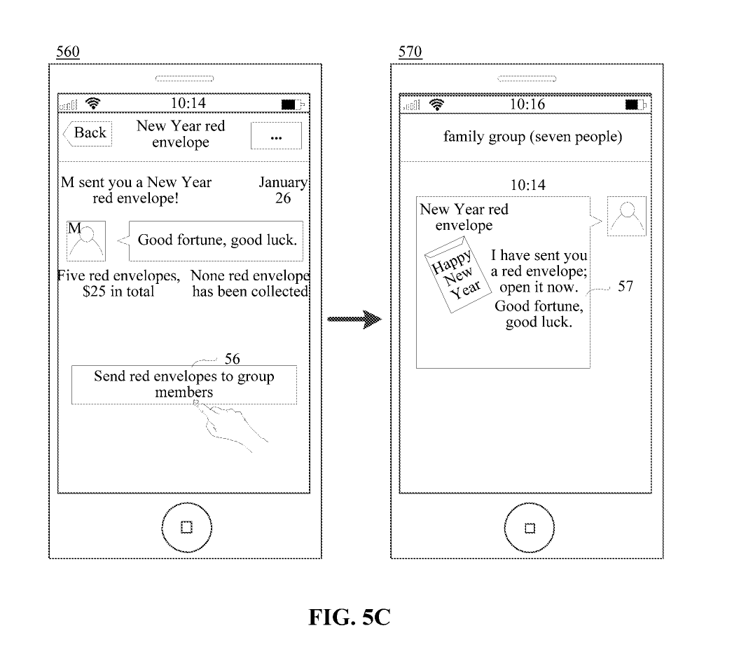

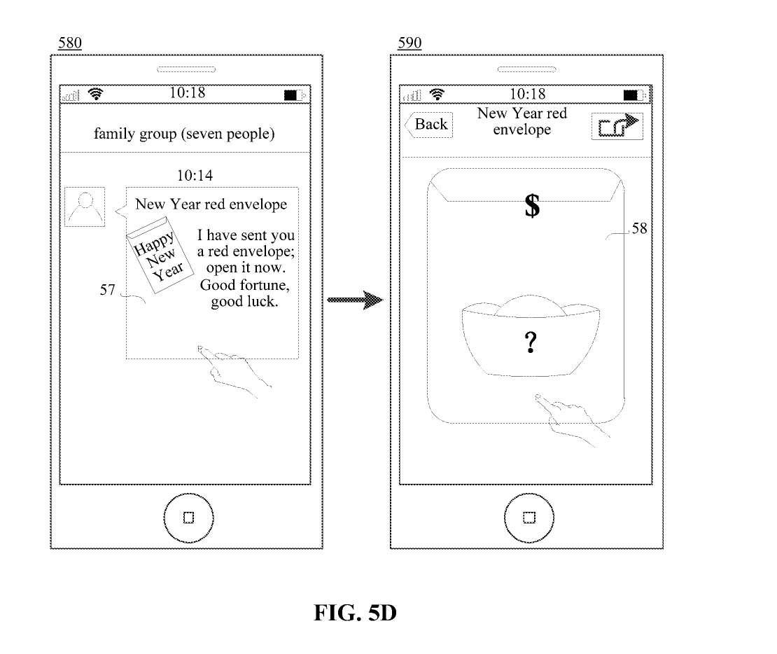

In some embodiments, to function both as a sender client device and as a recipient client device (at the same time or different times), a client device (e.g., the client device 12 or 16) is configured to distribute virtual items (e.g., a first type of virtual items) to a set of other client devices (functioning as recipient client devices), as well as receive virtual items distributed by other client devices (functioning as sender client devices). In such embodiments, the sender-client-portion and the recipient-client-portion of an application can be combined into one common portion of the application, and/or a single interface can be used to both send (functioning as a sending interface) and receive (functioning as a receiving interface) virtual items. User interfaces of a client device are shown and described in further detail with respect to FIGS. 5B-5D.

In some embodiments, a user operating the client device 12 or 16 (not shown in FIG. 1) can be any person (potentially) interested in using the service associated with distributing virtual items. The user can be interested in sending virtual items to her families, friends or other contacts; receiving virtual items from others; or both sending and receiving virtual items. Particularly, such a person can be, for example, a player of an online game, a member of an online community, a user of an instant messaging application, a user of a social networking application, and/or the like.

In some embodiments, a virtual item can be any type of item that can be transferred, exchanged, traded, transactioned, sold, circulated, etc., over a network (e.g., the Internet). Such a virtual item can be, for example, supplies for online gaming, materials for online gaming, virtual pets, virtual currency, icons, memberships, titles, value-added services (VAS), scores, points, gifts, gift cards, vouchers, coupons, greeting cards, money, and/or the like. Additionally, in some embodiments, a virtual item can be associated with or used to represent a physical item. In such embodiments, a transfer of virtual items can be associated with a transfer of corresponding physical items. For example, a transfer of a red envelope containing an amount of virtual money can be associated a transfer of a corresponding amount of real money between two bank accounts.

In some embodiments, an application can be associated with one or multiple types of virtual items. Thus, a user of the application can use the application to send and/or receive the one or multiple types of virtual items. For example, an online gaming application can be associated with (and thus providing a service to distribute) various types of game supplies, game materials, virtual currency, and/or the like. For another example, a social networking application or an instant messaging application can be associated with (and thus providing a service to distribute) virtual money, gift cards, greeting cards, and/or the like. Moreover, such an application can have a client-side portion (e.g., a sender-client-portion, a recipient-client-portion) implemented at a client device (e.g., the client devices 12, 16) and operated by a user of the client device, as well as a server-side portion implemented at a server device (e.g., the server device 14) that interacts with the client-side portions of the application.

FIG. 2 is a flowchart illustrating a method 200 performed at a sender client device for distributing virtual items in accordance with some embodiments. The sender client device performing the method 200 can be structurally and functionally similar to the client devices 12, 16 shown and described above with respect to FIG. 1. Particularly, the sender client device is configured to be operatively coupled to (e.g., via one or more networks similar to the networks 13, 15 in FIG. 1) and communicate with a server device (e.g., the server device 14 in FIG. 1) and one or more other client devices (e.g., the client devices 12, 16 in FIG. 1) that function as potential recipient client devices.

In some embodiments, the sender client device can include one or more processors and memory. The method 200 may be implemented using instructions or code of an application that are at least partially stored in a non-transitory computer readable storage medium of the sender client device and executed by the one or more processors of the sender client device. In such embodiments, the application is associated with distributing virtual items, and has a sender-client-portion that is stored in and/or executed at the sender client device, a recipient-client-portion that is stored in and/or executed at each potential recipient client device, and a server-side portion that is stored in and/or executed at the server device communicating with the sender client device and the potential recipient client device(s). As a result of such an application being executed, the method 200 is performed to distribute virtual items to a set of recipient client devices. As shown in FIG. 2, the method 200 includes the following steps.

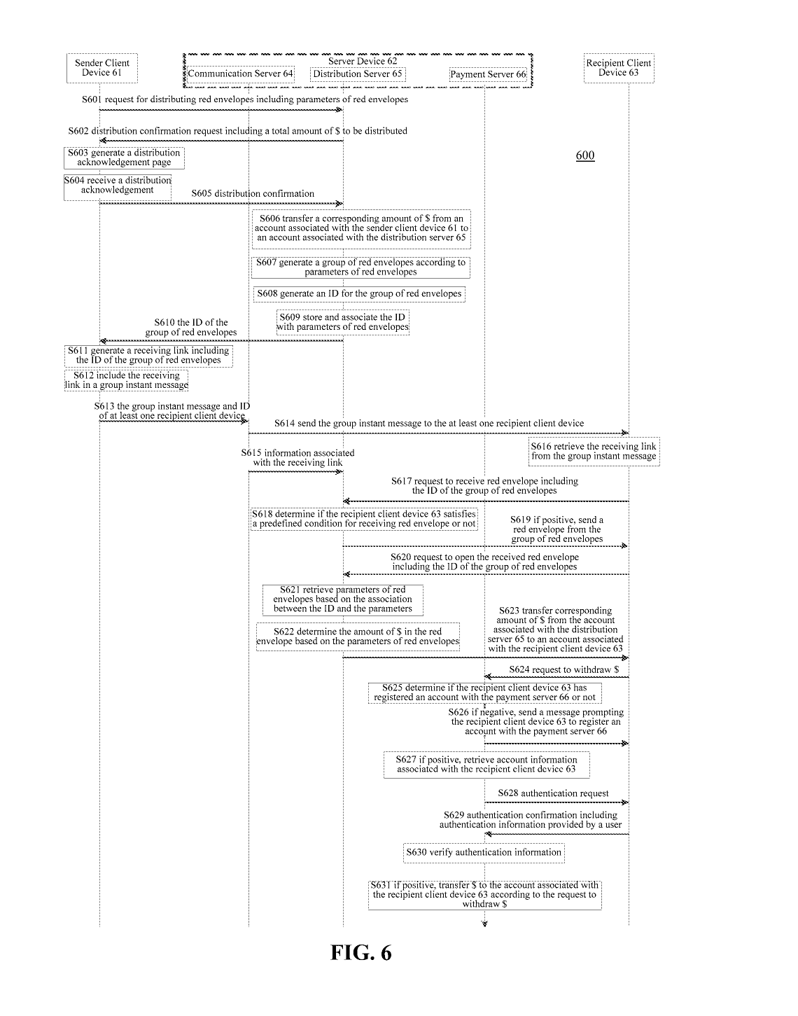

At S202, the sender client device interacts with the server device to generate a group of at least two virtual item packages, where each virtual item package from the group of virtual item packages includes at least one virtual item. In some embodiments, each virtual item package from the group of virtual item packages includes the same amount of virtual items. In other embodiments, virtual item packages from the group of virtual item packages include different amounts of virtual items. Details of the interaction between the sender client device and the server device to generate the group of virtual item packages are shown and described with respect to FIGS. 5A and 6.

At S204, the sender client device generates a link associated with the distribution of virtual items, wherein the link is used for distributing the group of virtual item packages. In some embodiments, the link is associated with distributing more than one virtual item package. That is, each of multiple different recipient client devices can use the same link to receive a different virtual item package, respectively. Furthermore, in some embodiments, a single recipient client device can repeatedly use the same link to receive more than one different virtual item package (at different times).

At S206, the sender client device sends the link to a set of recipient client devices such that the set of recipient client devices use the link to receive, from the server device, virtual item packages from the group of virtual item packages. In some embodiments, the user of the sender client device can operate the sender client device to define the set of recipient client devices (or users of the set of recipient client devices). For example, the user of the sender client device can define the users of the set of recipient client devices to be her friends and/or families; members of an online community to which the user of the sender client device belongs; contacts in an instant messaging application; members of a chat group or a chat room; people at a specific geographic area (e.g., within 100 meters from the sender client device); people with a specific characteristic (e.g., female contacts); and/or the like. In some embodiments, the user of the sender client device can define the users of the set of recipient client devices to be person(s) having any suitable type of social relationship with the user of the sender client device. Details of the interaction between the recipient client device(s) and the server device to receive the virtual item packages are shown and described with respect to FIGS. 5A and 6.

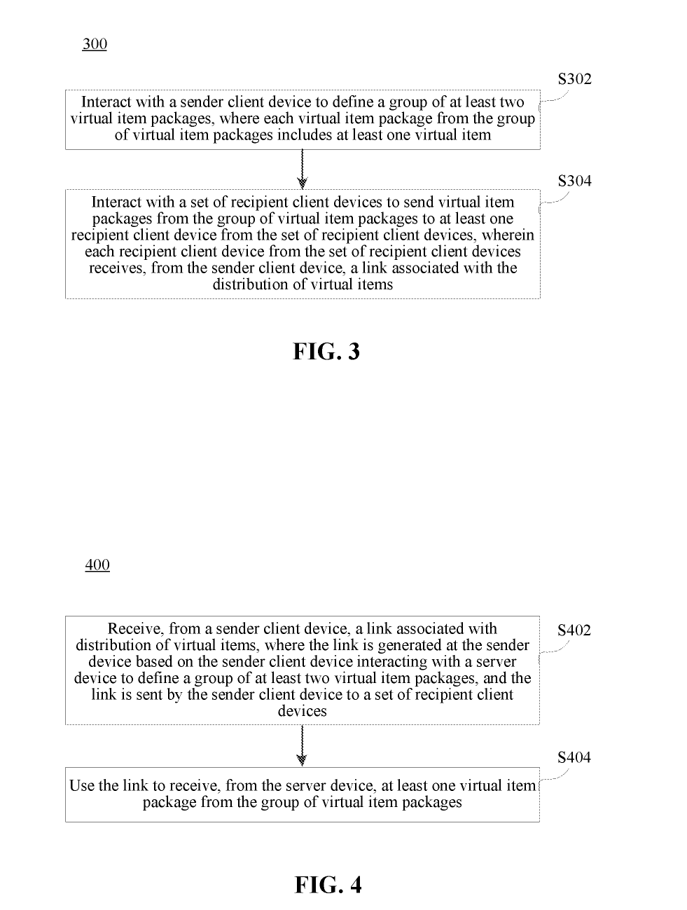

FIG. 3 is a flowchart illustrating a method 300 performed at a server device for distributing virtual items in accordance with some embodiments. The server device performing the method 300 can be structurally and functionally similar to the server device 14 shown and described above with respect to FIG. 1. Particularly, the server device is configured to be operatively coupled to (e.g., via one or more networks similar to the networks 13, 15 in FIG. 1) and communicate with a sender client device and one or more potential recipient client devices (e.g., the client devices 12, 16 in FIG. 1).

In some embodiments, the server device can include one or more processors and memory. The method 300 may be implemented using instructions or code of an application that are at least partially stored in a non-transitory computer readable storage medium of the server device and executed by the one or more processors of the server device. In such embodiments, the application is associated with distributing virtual items, and has a sender-client-portion that is stored in and/or executed at the sender client device, a recipient-client-portion that is stored in and/or executed at each potential recipient client device, and a server-side portion that is stored in and/or executed at the server device communicating with the sender client device and the potential recipient client device(s). As a result of such an application being executed, the method 300 is performed to distribute virtual items from the sender client device to a set of recipient client devices. As shown in FIG. 3, the method 300 includes the following steps.

At S302, the server device interacts with the sender client device to define a group of at least two virtual item packages, where each virtual item package from the group of virtual item packages includes at least one virtual item. Operations of the step S302 correspond to the operations of the step S202 of the method 200 in FIG. 2.

At S304, the server device interacts with a set of recipient client devices to send virtual item packages from the group of virtual item packages to at least one recipient client device from the set of recipient client devices. Each recipient client device from the set of recipient client devices receives, from the sender client device, a link associated with the distribution of virtual items. Operations of the step S304 correspond to the operations of the steps S204-S206 of the method 200 in FIG. 2. As described above with respect to FIG. 2, the sender client device can generate and send the link associated with the distribution of virtual items to the set of recipient client devices. Additionally, the user of the sender client device can operate the sender client device to define the set of recipient client devices (or users of the set of recipient client devices).

FIG. 4 is a flowchart illustrating a method 400 performed at a recipient client device for distributing virtual items in accordance with some embodiments. The recipient client device performing the method 400 can be structurally and functionally similar to the client devices 12, 16 shown and described above with respect to FIG. 1. Particularly, the recipient client device is configured to be operatively coupled to (e.g., via one or more networks similar to the networks 13, 15 in FIG. 1) and communicate with a server device (e.g., the server device 14 in FIG. 1), a sender client device (e.g., the client devices 12, 16 in FIG. 1), and/or one or more other devices (e.g., other client devices).

In some embodiments, the recipient client device can include one or more processors and memory. The method 400 may be implemented using instructions or code of an application that are at least partially stored in a non-transitory computer readable storage medium of the recipient client device and executed by the one or more processors of the recipient client device. In such embodiments, the application is associated with distributing virtual items, and has a sender-client-portion that is stored in and/or executed at the sender client device, a recipient-client-portion that is stored in and/or executed at the recipient client device, and a server-side portion that is stored in and/or executed at the server device communicating with the sender client device and the recipient client device. As a result of such an application being executed, the method 400 is performed to receive virtual items that are distributed from the sender client device. As shown in FIG. 4, the method 400 includes the following steps.

At S402, the recipient client device receives, from the sender client device, a link associated with distribution of virtual items. The link is generated at the sender device based on the sender client device interacting with the server device to define a group of at least two virtual item packages. The link is further sent by the sender client device to a set of recipient client devices including the recipient client device performing the method 400. Operations of the step S402 correspond to a portion of the operations of the steps S204-S206 of the method 200 in FIG. 2 and a portion of the operations of the step S304 of the method 300 in FIG. 3. As described above with respect to FIG. 2, the user of the sender client device can operate the sender client device to define the set of recipient client devices (or users of the set of recipient client devices), which includes the recipient client device performing the method 400.

At S404, the recipient client device uses the link to receive, from the server device, at least one virtual item package from the group of virtual item packages. Operations of the step S404 correspond to a portion of the operations of the step S206 of the method 200 in FIG. 2 and a portion of the operations of the step S304 of the method 300 in FIG. 3.

FIG. 5A is a flowchart illustrating a method 500 performed at a sender client device 51, a server device 52 and a recipient client device 53 for distributing virtual items in accordance with some embodiments. FIG. 5B—5D are schematic diagrams illustrating user interfaces of the client devices (i.e., the sender client device 51 and the recipient client device 53) associated with performing the method 500 in FIG. 5A. Although shown in FIGS. 5B-5D as a smart phone, in other embodiments, the sender client device 51 and/or the recipient client device 53 can be any other type of electronic device configured to communicate with the server device 52 and other client devices for sending and/or receiving virtual items.

The sender client device 51 and the recipient client device 53 can be structurally and functionally similar to the client devices 12, 16 shown and described above with respect to FIG. 1. The server device 52 can be structurally and functionally similar to the server device 14 shown and described above with respect to FIG. 1. Particularly, each of the sender client device 51, the server device 52 and the recipient client device 53 can include one or more processors and memory. Furthermore, the sender client device 51, the server device 52 and the recipient client device 53 are configured to be operatively coupled to (e.g., via one or more networks similar to the networks 13, 15 in FIG. 1, not shown in FIG. 5A) and communicate with each other. Additionally, although not shown in FIG. 5A, more than one recipient client device can be operatively coupled to and communicate with the sender client device 51 and the server device 52 to receive virtual items. Each of such recipient client devices can be similar to the recipient client device 53, and perform operations similar to those performed by the recipient client device 53 as described herein.

In some embodiments, the method 500 may be implemented using instructions or code of an application that are stored in non-transitory computer readable storage mediums of the sender client device 51, the server device 52 and the recipient client device 53, and executed by the processors of the sender client device 51, the server device 52 and the recipient client device 53. In such embodiments, the application is associated with distributing virtual items from the sender client device 51 to the recipient client device 53 via the server device 52. Such an application is similar to the applications described above with respect to the methods 200-400 in FIGS. 2-4.

Specifically, the application has a sender-client-portion that is stored in and/or executed at the sender client device 51, a recipient-client-portion that is stored in and/or executed at the recipient client device 52, and a server-side portion that is stored in and/or executed at the server device 53. In some embodiments, as described above with respect to FIG. 1, the sender-client-portion and the recipient-client-portion of the application can be the same. As a result of such an application being executed collectively at the sender client device 51, the server device 52 and the recipient client device 53, the method 500 is performed to distribute virtual items from the sender client device 51 to the recipient client device 53 via the server device 52. As shown in FIG. 5A, the method 500 includes the following steps.

At S501, the sender client device 51 sends to the server device 52 a request for distributing virtual items, where the request for distributing virtual items includes parameters associated with the distribution of virtual items. Specifically, a user of the sender client device 51 (denoted as “the sender” hereafter) can initiate the process of distributing virtual items by operating the sender client device 51 to generate and send the request for distributing virtual items to the server device 52. The sender can also operate the sender client device 51 to define the parameters associated with the distribution of virtual items. In some embodiments, for example, the sender client device 51 displays a user interface (e.g., a webpage) to a user of the sender client device 51 (i.e., a sender), prompting the sender to enter parameters associated with the requested distribution of virtual items. Subsequently, the sender client device 51 generates the request for distributing virtual items based on the parameters associated with the distribution of virtual items that are entered by the sender. The sender client device 51 then sends such a request to the server device 52.

In some embodiments, the parameters associated with a distribution of virtual items can include any type of parameter that is associated with defining a virtual item package containing virtual item(s) to be distributed. In some embodiments, the parameters can include one or more parameters such as, for example, the total amount of virtual items to be distributed, a total number of virtual item packages, an amount of virtual items associated with each virtual item package (e.g., a fixed amount of virtual items included in each virtual item package, a minimum amount of virtual items included in each virtual item package, a maximum amount of virtual items included in each virtual item package, etc.), and/or the like.

For example, the parameters can include the total amount of virtual items to be distributed and the total number of virtual item packages containing the virtual items to be distributed. Accordingly, the service device 52 can define the corresponding total number of virtual item packages, which contain the corresponding total amount of virtual items to be distributed. Furthermore, the amount of virtual items included in each virtual item package can be randomly (or in any other suitable arbitrary method) determined at the server device 52.

For another example, the parameters can include the total number of virtual item packages and a range of amount of virtual items to be included in each virtual item package. Such a range of amount of virtual items can be defined by, for example, a fixed amount of virtual items, or a pair of minimum and maximum amounts of virtual items. Accordingly, the service device 52 can define the corresponding total number of virtual item packages, each of which contains an amount of virtual items that falls within the range of amount of virtual items.

FIG. 5B is a schematic diagram illustrating user interfaces 530, 540 and 550 of the sender client device 51 associated with performing the method 500 of FIG. 5A. Particularly, as an example, the user interfaces 530, 540 and 550 are used for a sender (i.e., a user of the sender client device 51) to determine a method for distributing money (corresponding to virtual items) in the form of red envelopes. Specifically, the user interface 530 shown in FIG. 5B is configured to prompt the sender to select a method of defining red envelopes (corresponding to virtual item packages) to be distributed. The sender is prompted or instructed to click a button 54 to distribute money using “lucky group red envelopes” or to click a button 55 to distribute money using “ordinary red envelopes.” In the example shown in FIG. 5B, the method of “lucky group red envelopes” indicates a method for random generating red envelopes, while the method of “ordinary red envelopes” indicates a method for deterministically generating red envelopes.

To be specific, if the sender clicks the button 54 to select the method of “lucky group red envelopes,” the sender client device 51 is switched to display the user interface 540. As shown in FIG. 5B, the user interface 540 is configured to prompt the sender to enter parameters associated with the distribution including a total number of red envelopes to be sent and a total amount of money to be included in the red envelopes. The sender can then click a button “put money in red envelopes” to send the entered parameter values to the server device 52, which will subsequently define red envelopes in accordance with the parameter values entered by the sender.

Similarly, if the sender clicks the button 55 to select the method of “ordinary red envelopes,” the sender client device 51 is switched to display the user interface 550. As shown in FIG. 5B, the user interface 550 is configured to prompt the sender to enter parameters associated with the distribution including a total number of red envelopes to be sent and a fixed amount of money to be included in each red envelope. The sender can then click a button “put money in red envelopes” to send the entered parameter values to the server device 52, which will subsequently define red envelopes in accordance with the parameter values entered by the sender.

Returning to FIG. 5A, in some embodiments, a threshold amount can be predefined and used in entering parameters for a distribution of virtual items. Such a threshold amount can be provided by the sender or predefined as a default value for the application or service associated with distributing virtual items. In operation, when the sender enters a value for a specific parameter that represents a unit amount of virtual items and the entered value is greater than the threshold amount, then the sender client device 51 is configured to generate and present an alert message to the sender, indicating to the sender that the amount of virtual items she intends to include in a virtual item package might be too much. The sender can then modify the parameter value to control or reduce the amount of intended virtual item to be included in a virtual item package. In some embodiments, such a specific parameter can represent any type of virtual item amounts associated with a virtual item package such as, for example, an average amount of virtual items per virtual item package, a fixed amount of virtual items for each virtual item package, a minimum or maximum amount of virtual items for each virtual item package, etc.

At S502, in response to receiving the request for distributing virtual items, the server device 52 sends a distribution confirmation request to the sender client device 51, where the distribution confirmation request includes a total amount of virtual items to be distributed. Such a total amount of virtual items can be retrieved from the parameter values included in the request for distributing virtual items, or inferred or calculated based on the parameter values included in the request for distributing virtual items. For example, if the parameter values included in the request for distributing virtual items include a number of virtual item packages and a fixed amount of virtual items to be included in each virtual item package, then the total amount of virtual items to be distributed is a product of those two parameter values.

In some embodiments, the inferred or calculated total amount of virtual items can be an estimated value or a range of values. For example, if the parameter values included in the request for distributing virtual items include a number of virtual item packages and a range of virtual item amounts (e.g., including a minimum value and a maximum value) to be included in each virtual item package, then the total amount of virtual items to be distributed can be a range of virtual item amounts including a minimum total amount of virtual items (calculated as a product of the number of virtual item packages and the minimum virtual item amount for each virtual item package) and a maximum total amount of virtual items (calculated as a product of the number of virtual item packages and the maximum virtual item amount for each virtual item package).

In some embodiments, the distribution confirmation request is to inform, to the sender, the total amount of virtual items that will cost her to accomplish the requested distribution of virtual items. Furthermore, in some embodiments, the distribution confirmation request also serves as a request to the sender for transferring a corresponding amount of virtual items from an account associated with the sender (or alternatively, from an account associated with the sender client device 51) to an account associated with the server device 52.

At S503, after receiving the distribution confirmation request, the sender client device 51 generates a distribution acknowledgement page. Such a distribution acknowledgement page typically includes information associated with the requested distribution such as, for example, the total amount of virtual items to be distributed. The sender client device 51 further displays the distribution acknowledgement page to the sender, prompting the sender to review the information of the requested distribution, and to acknowledge the requested distribution.

At S504, the sender client device 51 receives, from the sender, a distribution acknowledgement in response to the distribution acknowledgement page. Such a distribution acknowledgement represents the confirmation of the sender with respect to the correctness or accuracy of the information displayed in the distribution acknowledgement page, and the agreement of the sender to proceed with the distribution process. In some embodiments, such a distribution acknowledgement also represents the agreement of the sender to transfer her corresponding virtual items to the account associated with the server device 52.

In some embodiments, the sender can generate such a distribution acknowledgement by manipulating the distribution acknowledgement page accordingly (e.g., pressing a “confirmation” button, clicking a link for acknowledging, pressing the Enter key, etc.). The sender typically reviews the information of the requested distribution (e.g., the total amount of virtual items to be distributed) provided in the distribution acknowledgement page before generating the distribution acknowledgement.

In some embodiments, the sender client device 51 can present information of the requested distribution to the sender and/or receive the sender's acknowledgement in any other suitable method. For example, the sender client device 51 can play an audio message containing information of the requested distribution. Correspondingly, the sender can be prompted or instructed to acknowledge the requested distribution using a voice command (e.g., “okay,” “yes,” “confirmed,” etc.).

At S505, in response to receiving the distribution acknowledgement from the sender, the sender client device 51 sends to the server device 52 a distribution confirmation signal that confirms the acknowledgement of the sender on performing the distribution of virtual items.

At S506, the server device 52 transfers a corresponding amount of virtual items from an account associated with the sender client device 51 to an account associated with the server device 52. In some embodiments, the amount of virtual items transferred corresponds to the total amount of virtual items included in the distribution confirmation request sent in the step S502. In some other embodiments, the amount of virtual items transferred can be different from the total amount of virtual items included in the distribution confirmation request sent in the step S502. For example, the server device 52 can charge a fee on performing the distribution, thus transferring an extra amount of virtual items (e.g., money) on top of the total virtual item amount that is requested to be distributed. Such an extra amount of virtual items can be calculated as, for example, a fixed percentage (e.g., 5%, 2%, etc.) of the virtual item amount to be distributed. For another example, the server device 52 can transfer a portion of the total virtual item amount to be distributed as a discount or promotion for the sender. Optionally, the server device 52 can transfer the remaining virtual item amount to be distributed at a later stage (e.g., a closing stage) of the distribution process.

In some embodiments, the account associated with the sender client device 51 can be any type of account, storage, database, collection, etc. that is associated with the sender's virtual items. Such an account can be, for example, a bank account of the sender, a storage of game supplies, a collection of greeting cards, an account associated with any type of financial assets of the sender, and/or the like. In some embodiments, a sender client device is shared by multiple users, thus an account associated with a user, instead of an account associated with the sender client device, is used in the distribution process.

At S507, the server device 52 defines a group of virtual item packages according to the parameters associated with the distribution of virtual items. In some embodiments, for example, the server device 52 can randomly assign virtual items to each virtual item package from the group of virtual item packages in accordance with the parameters associated with the distribution of virtual items. In other embodiments, the server device 52 can define the group of virtual item packages in any other suitable method in accordance with the parameters associated with the distribution of virtual items. Additionally, in some embodiments, the server device 52 can optionally send a confirmation message to the sender client device 51 after defining the group of virtual item packages. Such a confirmation message is to notify to the sender the successful generation of the group of virtual item packages in accordance with the parameters associated with the distribution.

At S508, the server device 52 generates an identifier for the defined group of virtual item packages. In some embodiments, the identifier is used to uniquely identify the group of virtual item packages. In such embodiments, the server device 52 can be configured to generate different identifiers for various groups of virtual item packages, where virtual item packages in the same group of virtual item package are identified by the same identifier. In some embodiments, such an identifier can be in any suitable form such as, for example, a text string of numbers, alphabets, symbols, etc.

At S509, the server device 52 stores and associates the identifier of the group of virtual item packages with the parameters associated with the distribution of virtual items. In some embodiments, the server device 52 can define different groups of virtual item packages according to different sets of parameters. As described above with respect to the step S508, the server device 52 can generate different identifiers for the different groups of virtual item packages, such that each identifier uniquely identifies a different group of virtual item packages. The server device 52 further stores and associates each identifier of a group of virtual item package with the corresponding set of parameters, based on which that group of virtual item package was defined at the step of S507.

As an example, Table 1 illustrates storing identifiers of a group of virtual item packages and the corresponding parameters, where each identifier of a group of virtual item packages is associated with a set of parameters, based on which virtual item packages from that group of virtual item packages were defined at the step of S507. In Table 1, “n” represents the total number virtual item packages in a group of virtual item packages, “s” represents a total amount of virtual items included in a group of virtual item packages, and “f” represents a fixed amount or an average amount of virtual items associated with each virtual item package from the group of virtual item packages. In some embodiments, such a table can be stored at a memory of the server device 52 or a storage device external and accessible to the server device 52.

TABLE 1

| identifiers of groups | parameters of |
|---|---|
| of virtual item packages | distribution |
| 20140128000001 | n = 5, s = 20 |
| 20140128000002 | n = 3, s = 35 |
| 20140128000003 | n = 20, f = 12.5 |
| 20140128000004 | n = 8, s = 1500 |
| . . . | . . . |

At S510, the server device 52 sends the identifier of the group of virtual item packages to the sender client device 51. The sender client device 51 stores the identifier of the group of virtual item packages at, for example, a memory of the sender client device 51. The sender client device 51 can then use the stored identifier to identify the group of virtual item packages in subsequent communications with the server device 52 and/or associated recipient client device(s) (e.g., the recipient client device 53). For example, the sender client device 51 can include the identifier in a receiving link that is to be sent to the associated recipient client device(s). For another example, the sender client device 51 can use the identifier to query remaining number of virtual item packages from the group of virtual item packages. For yet another example, the sender client device 51 can use the identifier to send to the server device 52 an instruction associated with recipient client device(s) that are permitted to receive a virtual item package from the group of virtual item packages.

As described above with respect to the steps S501-S510, the sender client device 51 interacts with the server device 52 to define virtual item packages in response to the request for distributing virtual items. Next, as described below with respect to the steps S511-S522, the sender client device 51, the server device 52 and the recipient client device 53 are configured to collectively distribute the defined virtual item packages, and to receive the distributed virtual item packages.

At S511, in response to receiving the identifier of the group of virtual item packages, the sender client device 51 generates a receiving link associated with the distribution of virtual items. In some embodiments, such a receiving link includes the identifier of the group of virtual item packages, or any other information that can be used to uniquely identify this group of virtual item packages and/or this distribution of virtual items.

In some embodiments, the receiving link is used to distribute virtual item packages from the group of virtual item packages to more than one targeted recipient client device. In such embodiments, the same receiving link is sent to the more than one targeted recipient client device, each of which then displays the receiving link and prompts a user of that recipient client device to receive a virtual item package using the receiving link. In some embodiments, a receiving link can be used to distribute virtual item packages from a group of virtual item packages to any number of targeted recipient client devices.

In some other embodiments, a receiving link is used to send a virtual item package from a group of virtual item packages to a single targeted recipient client device. In such embodiments, a sender client device can generate different receiving links for each different targeted recipient client device. The different receiving links can include the same identifier associated with the same group of virtual item packages. In some embodiments, the receiving links for different recipient client devices can be slightly different from each other. For example, each receiving link can use a different index number.

At S512, the sender client device 51 sends the receiving link to a set of recipient client devices including the recipient client device 53. In some embodiments, as described above with respect to FIG. 2, the sender can define the set of recipient client devices that are potentially to receive virtual item packages from the group of virtual item packages. Alternatively, the sender can define a set of human recipients, each of which is a user of a recipient client device (e.g., the recipient client device 53) that is potentially to receive virtual item packages from the group of virtual item packages. In some embodiments, the set of recipient client device can include a single recipient client device (i.e., the recipient client device 53). In other embodiments, the set of recipient client device can include multiple recipient client devices including the recipient client device 53.

In some embodiments, a user of each recipient client device from the set of recipient client devices has a social relationship with the sender. Such a social relationship can be, for example, the sender's friends and/or families; members of an online community to which the sender belongs; contacts of the sender in an instant messaging application; members of a chat group or a chat room to which the sender belongs; people at a specific geographic area associated with the sender (e.g., within 100 meters from the sender client device); people with a specific characteristic (e.g., female contacts of the sender); and/or the like.

The sender client device 51 can send the receiving link to each recipient client device from the set of recipient client devices in any suitable method. In some embodiments, the sender client device 51 can include the receiving link in an instant message and then send the instant message to each recipient client device from the set of recipient client devices. Thus, the sender client device 51 separately sends an instant message to each recipient client device from the set of recipient client devices. The total number of instant messages sent from the sender client device 51 is equal to the total number of recipient client devices included in the set of recipient client devices. Furthermore, in such embodiments, each user of a recipient client device from the set of recipient client devices is a contact of the sender in the instant messaging application, thus able to receive instant messages from the sender.

In some embodiments, the sender client device 51 can include the receiving link in a group instant message and then send the group instant message to a group of contacts, where each other member in the group is a potential receiver of the virtual item packages to be distributed. In other words, each recipient client device from the set of recipient client devices is operated by a member of the group. In such embodiments, the sender client device 51 sends a single group instant message and each recipient client device from the set of recipient client devices receives the receiving link via the group instant message.

FIG. 5C is a schematic diagram illustrating user interfaces 560 and 570 of the sender client device 51 associated with performing the method 500 of FIG. 5A. Particularly, as an example, the user interfaces 560 and 570 illustrate the sender client device 51 sending a group instant message including a receiving link to a set of recipient client devices (or to a set of receivers). As shown in FIG. 5C, the sender clicks a button 56 in the user interface 560 to initiate sending the receiving link to members of a group. Subsequently, although not shown in FIG. 5C, the sender can be prompted to select a group to send the receiving link to. Such a group can be, for example, a family group for the sender. As a result, the sender sends a group instant message containing the receiving link to the group. As shown in FIG. 5C, the user interface 570 illustrates that the group instant message 57 sent by the sender is displayed in the instant messaging application and viewable to the sender via the sender client device 51.

Returning to FIG. 5A, in some embodiments, the sender can present the receiving link to potential receivers by posting the receiving link at a social media website, social networking website, a microblogging website, etc. under an account of the sender. Such websites or services can include, for example, Facebook, Twitter, MySpace, LinkedIn, Google Buzz, SnapChat, Instagram, Sina Weibo, Tencent Weibo, Wechat, and/or the like. In such embodiments, any friend of the sender on that website who is given access to the sender's postings can see the receiving link. Thus, similar to the method of sending a group instant message, the sender sends the receiving link to multiple potential receivers without sending a message separately to each potential receiver. Additionally, in some embodiments, the sender can use an access control mechanism (e.g., define a filter) to control the targeted receiver(s) of the posting that contains the receiving link.

In some embodiments, the sender client device 51 can generate a barcode containing information associated with the receiving link. The sender client device 51 can then display the barcode at the sender client device 51 (e.g., on a screen of the sender client device 51) such that a recipient client device can receive information of the receiving link by scanning the barcode displayed at the sender client device 51. Such a barcode can be a one-dimensional or linear barcode (e.g., Code 93), a two-dimensional or matrix barcode (e.g., QR code), or any other type of barcode. In such a method, the sender can display the barcode to any person with whom the sender has contact, thus sending the receiving link to a recipient client device associated with that person.

At S513, the sender client device 51 sends information associated with the receiving link to the server device 52. In some embodiments, the associated information includes, for example, an identifier of the sender client device 51 (or an identifier of the sender), an identifier of each recipient client device from the set of recipient client devices (or an identifier of each receiver), and/or the identifier of the group of virtual item packages. In such embodiments, the identifier of the sender client device 51 can be used to uniquely identify the sender client device 51, and the identifier of each recipient client device (e.g., the recipient client device 53) can be used to uniquely identify that recipient client device. Thus, the information sent from the sender client device 51 to the server device 52 can be used to uniquely identify this distribution of virtual items. Furthermore, the information can be used to associate the sender client device 51 and the set of recipient client devices (including the recipient client device 53) with the group of virtual item packages to be distributed.

In some embodiments, when a sender client device sends a receiving link to a set of recipient client devices using one or more instant messages (e.g., a group instant message or multiple individual instant messages), a server configured to forward the instant message(s) can be configured to send the information associated with the receiving link to the server device 52. Furthermore, in some embodiments, such a server can be configured to automatically retrieve the information of the receiving link from the instant message(s), and then send the information to the server device 52. As a result, the sender client device 51 is not necessarily required to send the information associated with the receiving link to the server device 52.

In some embodiments, when a sender client device sends a receiving link to a set of recipient client devices using one or more instant messages (e.g., a group instant message or multiple individual instant messages), the sender client device has information of each targeted recipient client device. In such embodiments, the information provided to the server device 52 can include the identifier of the sender client device, the identifier of each recipient client device from the set of recipient client devices, and the identifier of the group of virtual item packages.

In some other embodiments, when a sender client device posts a message including a receiving link or generates a barcode containing information of a receiving link, the sender client device does not necessarily have information of each recipient client device that will receive the receiving link. In such embodiments, the information provided to the server device 52 can include the identifier of the sender client device and the identifier of the group of virtual item packages. Additionally, the information provided to the server device 52 can optionally include identifiers of one or more recipient client devices that might potentially receive the receiving link.

At S514, the server device 52 stores and associates the identifier of the sender client device 51 and the identifier(s) of the set of recipient client devices with the identifier of the group of virtual item packages. Specifically, for each group of virtual item packages defined at the server device 52, the identifier of that group of virtual item packages is associated with the identifier of a single sender client device (e.g., the sender client device 51). Optionally, the identifier of that group of virtual item package is also associated with the identifier(s) of one or more recipient client devices from the targeted set of recipient client devices.

At S515, the recipient client device 53 obtains the receiving link that is sent from the sender client device 51 to the recipient client device 53 at the step S512. Corresponding to the various methods of sending the receiving link described above with respect to the step S512, the recipient client device 53 can receive the receiving link in various methods such as, for example, receiving an individual instant message or a group instant message that contains the receiving link, accessing a message containing the receiving link that is posted at a social networking website, scanning a barcode containing information of the receiving link, and/or the like. In some embodiments, the recipient client device 53 further displays the receiving link to the recipient (i.e., a user of the recipient client device 53).

At S516, the recipient client device 53 sends to the server device 52 a request to receive virtual items. Specifically, the recipient can operate the recipient client device 53 to send the request to receive virtual items by, for example, clicking the receiving link displayed at the recipient client device 53. In some embodiments, the request to receive virtual items includes information associated with the distribution of virtual items such as, for example, the identifier of the recipient client device 53, the identifier of the group of virtual item packages, a number of requested virtual item packages, and/or any other suitable information.

At S517, the server device 52 determines if the recipient client device 53 satisfies a predefined condition for receiving virtual items. Alternatively, the server device 52 can determine if the recipient satisfies a predefined condition for receiving virtual items. Such a predefined condition can be a combination of multiple conditions such as, for example, the identifier of the recipient client device being associated with the identifier of the group of virtual item packages (and optionally, being associated with the identifier of the sender client device) as stored in the server device 52 at the step S514; the number of remaining virtual item package(s) from the group of virtual item packages being greater than zero; the recipient client device having not received any virtual item package from the group of virtual item packages, and/or the like.

For example, the server device 52 determines that the recipient client device 53 satisfies the predefined condition if the identifier of the recipient client device 53 is associated with the identifier of the group of virtual item packages and such an association is stored at the server device 52, and there is at least one virtual item package from the group of virtual item packages that has not been distributed or assigned to a recipient client device. As such, the receiver can use the recipient client device 53 to receive more than one virtual item package from the group of virtual item packages. For another example, the predefined condition further requires that the recipient client device 53 has not yet received any virtual item package from the group of virtual item packages. As a result, the receiver can use the recipient client device 53 to receive at most one virtual item package from the group of virtual item packages.

In some embodiments, a determination of the identifier of the recipient client device 53 being associated with the identifier of the group of virtual item packages indicates that the recipient client device 53 is one of the targeted recipient client device(s) associated with this distribution of virtual items. In other words, such a determination verifies that the sender client device 51 sent the receiving link to the recipient client device 53. Thus, the receiving client device 53 is qualified to receive virtual items to be distributed, subject to other predefined condition(s) also being satisfied. Additionally, in some embodiments, the predefined condition for receiving the virtual items includes that a user of a recipient client device (i.e., a receiver) has a predefined social relationship with the sender.

At S518, if the server device 52 determines that the recipient client device 53 satisfies the predefined condition for receiving virtual items (alternatively, if the server device 52 determines that the receiver satisfies the predefined condition for receiving virtual items), then the server device 52 sends a virtual item package from the group of virtual item packages to the recipient client device 53.

In some embodiments, the server device 52 can select the virtual item package, which is to be sent to the recipient client device 53, in any suitable method. For example, the server device 52 can randomly select a virtual item package from the virtual item packages that have not yet been distributed. For another example, the server device 52 can select a virtual item package from the group of virtual item packages based on an order of the virtual item packages being generated (at the step of S507). For yet another example, the server device 52 can select a virtual item package from the group of virtual item packages based on an order of the virtual item packages being stored at the server device 52.

In some embodiments, the server device 52 can optionally send a confirmation message to the sender client device 51 and/or the recipient client device 53 after successfully sending a virtual item package to the recipient client device 53. Such a confirmation message can be used to notify to the sender and/or the receiver the successful transfer of the virtual item package from the server device 52 to the recipient client device 53.

In some embodiments, although not shown in FIG. 5A, if the server device 52 determines that the recipient client device 53 does not satisfy the predefined condition for receiving virtual items (alternatively, if the server device 52 determines that the recipient does not satisfy the predefined condition for receiving virtual items), then the server device 52 sends a message to the recipient client device 53 rejecting the request to receive virtual items. As a result, no virtual item package from the group of virtual item packages is sent from the server device 52 to the recipient client device 53.

At S519, after receiving the virtual item package, the recipient client device 53 sends to the server device 52 a request to open the received virtual item package. In some embodiments, for example, the recipient client device 53 presents a message (e.g., a text message, an image, an icon, an audio message, etc.) to the receiver, notifying to the receiver that a virtual item package has been successfully received. The receiver can then operate the recipient client device 53 to generate and send the request to open to the server device 52 by, for example, clicking a link in the text message, clicking an icon in the image, responding an audio message (e.g., “open,” “withdraw,” “confirm,” “check,” etc.), and/or the like.

In some embodiments, the request to open can include information that is used to identify the virtual item package and/or the recipient client device 53. For example, the request to open can include the identifier of the group of virtual item packages and/or the identifier of the recipient client device 53. In some embodiments, although not shown in FIG. 5A, the recipient client device 53 can receive virtual items included in a virtual item package without sending such a request to open. In such embodiments, the server device 52 can be configured to automatically perform operations of the remaining steps S520-S522 to distribute corresponding virtual items to the recipient client device 53 without receiving a request to open the virtual item package.

At S520, in response to receiving the request to open the virtual item package, the server device 52 retrieves the parameters associated with the distribution of virtual items. Specifically, the server device 52 can retrieve the parameters associated with the distribution based on the association between the identifier of the group of virtual item packages and the parameters of the distribution, which is stored at the server device 52 at the step S509 described above.

Subsequently, at S521, the server device 52 determines the amount of virtual items in the virtual item package based on the parameters of the distribution. For example, if the parameters include a total amount of virtual items to be distributed and a total number of virtual item packages, the server device 52 can randomly determine, based on the remaining total amount of virtual items and the remaining number of virtual item packages, the amount of virtual items included in the virtual item package sent to the recipient client device 53. For another example, if the parameters include a fixed amount of virtual items to be included in each virtual item package and a total number of virtual item packages, the server device 52 can determine that the amount of virtual items included in the virtual item package sent to the recipient client device 53 is that fixed amount.

In some embodiments, as an alternative approach to the steps S520-S521, amounts of virtual items included in each virtual item package are determined at the step S507 described above when the server device 52 defines the group of virtual item packages according to the associated parameters. That is, the amount of virtual items included in each virtual item package from the group of virtual item packages has already been determined before a virtual item package from the group of virtual item packages is selected and sent to the recipient client device 53 at the step S518. As a result, when the server device 52 selects a virtual item package from the group of virtual item packages at the step S518, the amount of virtual items distributed to the recipient client device 53 is determined. Thus, the steps S520-S521 can be omitted.

Similarly, in some embodiments, amounts of virtual items included in a subgroup of virtual item packages from the group of virtual item packages are determined at the step S507 described above when the server device 52 defines the group of virtual item packages according to the associated parameters. The subgroup of virtual item packages can include one or more virtual item packages from the group of virtual item packages. The determined amounts of virtual items included in the virtual item packages from the subgroup of virtual item packages can be stored at, for example, a cache memory of the server device 52. As a result, when the server device 52 selects a virtual item package from the subgroup of virtual item packages for a recipient client device (at the step S518), the amount of virtual items included in that virtual item package has already been determined. Thus the steps S520-S521 can be omitted.

At S522, the server device 52 transfers a corresponding amount of virtual items from the account associated with the server device 52 to an account associated with the recipient client device 53 (alternatively, an account associated with the receiver). Thus, the process of distributing virtual items from the sender client device 51 to the recipient client device 53 is completed.

In some embodiments, similar to the account associated with the sender client device 51, the account associated with the recipient client device 53 can be any type of account, storage, database, collection, etc. that is associated with the receiver's virtual items. Such an account can be, for example, a bank account of the receiver, a storage of game supplies, a collection of greeting cards, an account associated with any type of financial assets of the receiver, and/or the like. In some embodiments, a recipient client device is shared by multiple users, thus an account associated with a user, instead of an account associated with the recipient client device, is used in the distribution process.

FIG. 5D is a schematic diagram illustrating user interfaces 580 and 590 of the recipient client device 53 associated with performing the method 500 of FIG. 5A. Particularly, as an example, the user interfaces 580 and 590 illustrate the recipient client device 53 receiving money included in a red envelope (i.e., virtual items included in a virtual item package). As shown in FIG. 5D, the user interface 580 illustrates that the group instant message 57 sent by the sender is displayed in the instant messaging application and viewable to the receiver via the recipient client device 51. Such a group instant message corresponds to the group instant message displayed in the instant messaging application and viewable to the sender via the sender client device 51 as shown in the user interface 570 in FIG. 5C.

The group instant message 57 functions as a receiving link associated with receiving a red envelope. As shown in FIG. 5D, the receiver is prompted to click the group instant message 57 to receive a red envelope. As a result, the recipient client device 53 displays to the receiver a red envelope icon 58 in the user interface 590, indicating that the receiver has successfully received a red envelope. The receiver is then prompted to click the red envelope icon 58 to send a request to open the red envelope to the server device 52. Subsequently, money included in the red envelope sent to the receiver is transferred to an account of the receiver.

FIG. 6 is a flowchart illustrating another method 600 performed at a sender client device 61, a server device 62 and a recipient client device 63 for distributing virtual items in accordance with some embodiments. Although shown in FIG. 6 as red envelopes containing money being distributed, in other embodiments, the method 600 can be used to distribute any other type of virtual items described above with respect to FIG. 1.

The sender client device 61 and the recipient client device 63 can be structurally and functionally similar to the client devices 12, 16 shown and described above with respect to FIG. 1. The server device 62 can be structurally and functionally similar to the server device 14 shown and described above with respect to FIG. 1. Particularly, as shown in FIG. 6, the server device 62 can be a cluster of servers including, for example, a communication server 64, a distribution server 65 and a payment server 66. The communication server 64 is configured to enable communications between the server device 62 and the client devices operatively coupled to the server device 62 (e.g., the sender client device 61, the recipient client device 63). The distribution server 65 is configured to perform functions associated with generating and/or distributing virtual item packages (e.g., red envelopes). The payment server 66 is configured to perform functions associated with transferring virtual items (e.g., money).

In some embodiments, each of the sender client device 61, the server device 62 (including the communication server 64, the distribution server 65 and the payment server 66) and the recipient client device 63 can include one or more processors and memory. Furthermore, the sender client device 61, the server device 62 and the recipient client device 63 are configured to be operatively coupled to (e.g., via one or more networks similar to the networks 13, 15 in FIG. 1, not shown in FIG. 6) and communicate with each other. Additionally, although not shown in FIG. 6, more than one recipient client device can be operatively coupled to and communicate with the sender client device 61 and the server device 62 to receive virtual items. Each of such recipient client devices can be similar to the recipient client device 63, and perform operations similar to those performed by the recipient client device 63 as described herein.

In some embodiments, the method 600 may be implemented using instructions or code of an application that are stored in non-transitory computer readable storage mediums of the sender client device 61, the server device 62 (including the communication server 64, the distribution server 65 and the payment server 66) and the recipient client device 63, and executed by the processors of the sender client device 61, the server device 62 and the recipient client device 63. In such embodiments, the application is associated with distributing red envelopes containing money from the sender client device 61 to the recipient client device 63 via the server device 62. Such an application is similar to the applications described above with respect to the methods 200-500 in FIGS. 2-4 and 5A.

Specifically, the application has a sender-client-portion that is stored in and/or executed at the sender client device 61, a recipient-client-portion that is stored in and/or executed at the recipient client device 63, and at least one server-side portion that is stored in and/or executed at the server device 63. In some embodiments, as described above with respect to FIG. 1, the sender-client-portion and the recipient-client-portion of the application can be the same. As a result of such an application being executed collectively at the sender client device 61, the server device 62 and the recipient client device 63, the method 600 is performed to distribute red envelopes containing money from the sender client device 61 to the recipient client device 63 via the server device 62. As shown in FIG. 6, the method 600 includes the following steps.

Steps S601-S610 describe a process of the sender client device 61 and the server device 62 collectively generating red envelopes. At S601, the sender client device 61 sends to the distribution server 65 a request for distributing red envelopes. Such a request includes parameters used to define the red envelopes such as, for example, a total number of red envelopes to be generated, a total amount of money to be put into the red envelopes, an average amount of money to be put into each red envelope, a minimum and/or maximum amount of money to be put into each red envelope, and/or the like. In some embodiments, a sender (i.e., a user of the sender client device 61) operates the sender client device 61 to generate and send the request for distribution red envelopes to the distribution server 65. Correspondingly, the distribution server 65 receives the request for distributing red envelopes from the sender client device 61.

At S602, in response to receiving the request for distributing red envelopes, the distribution server 65 sends a distribution confirmation request to the sender client device 61. Such a distribution confirmation request includes a total amount of money to be put into the red envelopes to be generated. As described above with respect to the step S502 of the method 500 in FIG. 5A, such a total amount of money can be retrieved, inferred or calculated from the parameters included in the request for distributing red envelopes. Correspondingly, the sender client device 61 receives the distribution confirmation request from the distribution server 65.

At S603, after receiving the distribution confirmation request, the sender client device 61 generates a distribution acknowledgement page. The sender client device 61 further displays the distribution acknowledgement page to the sender, prompting the sender to review information of the requested distribution (e.g., the total amount of money to be distributed using the red envelopes) that is included in the distribution acknowledgement page, and to acknowledge the requested distribution. At S604, the sender client device 61 receives, from the sender, a distribution acknowledgement in response to the distribution acknowledgement page.

At S605, in response to receiving the distribution acknowledgement from the sender, the sender client device 61 sends to the distribution server 65 a distribution confirmation signal that confirms the acknowledgement of the sender on performing the distribution of money using red envelopes.

At S606, the distribution server 65 transfers a corresponding amount of money from an account associated with the sender client device 61 (e.g., a bank account of the sender) to an account associated with the distribution server 65 (e.g., a bank account associated with the server device 62). In some embodiments, the amount of money transferred corresponds to the total amount of money included in the distribution confirmation request sent in the step S602. In some embodiments, the account associated with the sender client device 61 and the account associated with the distribution server 65 can be virtual accounts that are stored and maintained at the server device 62. In such embodiments, virtual money (i.e., virtual representations of money) can be deposited into and withdrawn from such a virtual account, and virtual money can be transferred between such virtual accounts.

Moreover, in some embodiments, a transaction of money between real accounts (e.g., bank accounts) can be performed along with a transfer of virtual money between two virtual accounts. For example, when an amount of virtual money is transferred from a virtual account associated with the sender client device 61 to a virtual account associated with the server device 62, a corresponding amount of money is also transferred from a bank account of the sender to a bank account associated with the server device 62.

At S607, the distribution server 65 defines a group of red envelopes according to the parameters of red envelopes. Each red envelope from the group of red envelopes contains a nonzero amount of money, and the total amount of money contained in the group of red envelopes corresponds to the amount of money transferred from the account associated with the sender client device 61 to the account associated with the distribution server 65.

At S608, the distribution server 65 generates an identifier for the group of red envelopes, such that the identifier can be used to uniquely identify the group of red envelopes. At S609, the distribution server 65 stores and associates the identifier of the group of red envelopes with the parameters of red envelopes. At S610, the distribution server 65 sends the identifier of the group of red envelopes to the sender client device 61. Correspondingly, the sender client device 61 receives the identifier of the group of red envelopes.

Steps S611-S615 describe a process of the sender client device 61 and the server device 62 collectively distributing red envelopes. At S611, in response to receiving the identifier of the group of red envelopes, the sender client device 61 generates a receiving link associated with the distribution of red envelopes. Such a receiving link can include the identifier of the group of red envelopes. At S612, the sender client device 61 generates a group instant message and includes the receiving link in the group instant message. In some embodiments, such a group instant message can include, for example, a text message, an image, a link, an icon, a symbol, and/or the like. In some embodiments, the receiving link can be embedded within the group instant message such that a user can access the receiving link by, for example, clicking the group instant message received at the user's recipient client device.

At S613, the sender client device 61 sends the group instant message and identifier(s) of at least one targeted recipient client device (e.g., the recipient client device 63) to the communication server 64. The targeted recipient client device(s) are the recipient client device(s) to which the sender intends to send the red envelopes. Alternatively, users of the targeted recipient client device(s) are the targeted people to whom the sender intends to send the red envelopes. In some embodiments, for example, members of a group (e.g., an online community, a chat room, a group of users in an instant messaging application, a circle in a social networking application, etc.) are targeted receivers to whom the sender indents to send the red envelopes. In such embodiments, the sender is also a member of that group, and recipient client devices operated by the members of the group are the targeted recipient client devices.

At S614, the communication server 64 sends the group instant message to the at least one targeted recipient client device including the recipient client device 63. For example, the sender sends the group instant message to a group including the sender, and as a result, each member of the group receives that group instant message using her recipient client device. Correspondingly, the recipient client device 63 receives the group instant message that contains the receiving link.

At S615, the communication server 64 sends information associated with the receiving link to the distribution server 65. In some embodiments, the information associated with the receiving link includes, for example, an identifier of the sender client device 61 (or an identifier of the sender), the identifier of each targeted recipient client device including the recipient client device 63 (or an identifier of each receiver), and/or the identifier of the group of red envelopes. Correspondingly, the distribution server 65 receives and stores the information associated with the receiving link.

Subsequently, steps S616-S619 describe a process of the recipient client device 63 receiving a red envelope. At S616, the recipient client device 63 retrieves the receiving link from the group instant message received from the communication server 64. In response to retrieving the receiving link, at S617, the recipient client device 63 sends a request to receive a red envelope to the distribution server 65. Such a request to receive a red envelope can include the identifier of the group of red envelopes that is included in the receiving link. In some embodiments, the receiver can operate the recipient client device 63 to send the request to receive a red envelope by, for example, clicking the group instant message or the receiving link embedded within the group instant message, where the group instant message and/or the receiving link are displayed at the recipient client device 63.

At S618, the distribution server 65 determines if the recipient client device 63 satisfies a predefined condition for receiving a red envelope from the group of red envelopes. Alternatively, the distribution server 65 can determine if the human receiver satisfies a predefined condition for receiving a red envelope from the group of red envelopes. Such a predefined condition can be, for example, the receiver being a member of the group to which the sender intends to send the red envelopes; the receiver having a specific social relationship with the sender; the recipient client device is one of the targeted recipient client devices whose identifiers are received and stored at the distribution server 65 (at the step S615); and/or any other suitable condition.

At S619, if the distribution server 65 determines that the recipient client device 63 satisfies the predefined condition for receiving a red envelope from the group of red envelopes (alternatively, if the distribution server 65 determines that the receiver satisfies the predefined condition for receiving a red envelope from the group of red envelopes), then the distribution server 65 sends a red envelope from the group of red envelopes to the recipient client device 63. Correspondingly, the recipient client device 63 receives the red envelope from the distribution server 65.

Next, steps S620-S623 describe a process of the recipient client device 63 interacting with the server device 62 to open the received red envelope. At S620, after receiving the red envelope, the recipient client device 63 sends to the distribution server 65 a request to open the received red envelope. Such a request to open includes the identifier of the group of red envelopes. Correspondingly, the distribution server 65 receives the request to open the red envelope.

At S621, in response to receiving the request to open the red envelope, the distribution server 65 retrieves the parameters of red envelopes. Specifically, the distribution server 65 can retrieve the parameters of red envelopes based on the association between the identifier of the group of red envelopes and the parameters of red envelopes, which is stored at the distribution server 65 at the step S609 described above. Subsequently, at S622, the distribution server 65 determines the amount of money in the red envelope based on the retrieved parameters of red envelopes.

At S623, the distribution server 65 transfers a corresponding amount of money from the account associated with the distribution server 65 to an account associated with the recipient client device 63 (alternatively, an account associated with the human receiver). In some embodiments, similar to the account associated with the distribution server 65 and the account associated with the sender client device 61, the account associated with the recipient client device 63 (or the account associated with the receiver) can be a virtual account stored and maintained at the server device 62. In such embodiments, when the step S623 is performed, a corresponding amount of virtual money is transferred from a virtual account associated with the server device 62 to the virtual account associated with the recipient client device 63. However, no money is yet transferred from a bank account associated with the server device 62 to any bank account of the receiver.

In some embodiments, as described above with respect to the steps S520-S521, the distribution server 65 can take an alternative approach to determine the amount of money in the red envelope sent to the recipient client device. Specifically, the amount of money included in the red envelope can be determined when the group of red envelopes are generated at the distribution server 65 (e.g., at the step S607) prior to that red envelope being selected and sent to the recipient client device 63 (e.g., at the step S619). Thus, the steps S621-S622 can be omitted.

Finally, steps S624-S631 describe a process of the recipient client device 63 (or the human receiver) withdrawing money from the red envelope. At S624, the recipient client device 63 sends, to the payment server 66, a request to withdraw money from an account (e.g., a virtual account) associated with the recipient client device 63. The request to withdraw includes a requested amount of money, which typically is equal to or less than the amount of money included in the red envelope received at the recipient client device 63. In some embodiments, if a total amount of money (e.g., virtual money) in the account (e.g., a virtual account) associated with the recipient client device 63 is more than the amount of money included in the red envelope, the requested amount money can be equal to or less than the total amount of money in the account, but more than the amount of money included in the red envelope. For example, the receiver can wait to withdraw money after receiving two or more red envelopes. Thus, the receiver can request to withdraw an amount of money that is more than the amount of money included in any of the red envelopes she received.

At S625, the payment server 66 determines if the recipient client device 63 has registered an account (e.g., bank account) with the payment server 66 or not. Alternatively, the payment server 66 determines if the human receiver has registered an account with the payment server 66 or not. In some embodiments, in order to enable transactions (e.g., of money) with the payment server 66, a user is required to register an account (e.g., a bank account) of the user with the payment server 66. In such embodiments, the user cannot withdraw money from an account (e.g., bank account) of the payment server 66 unless the user has registered an account with the payment server 66. In some other embodiments, a user can receive money from an account of the payment server 66 without registering an account of the user with the payment server 66. In such embodiments, for example, the user can be requested to provide account information to complete the transaction, and such account information is not stored at the payment server 66 after the transaction is completed.

At S626, if the payment server 66 determines that the recipient client device 63 (or the receiver) has not register an account with the payment server 66, then the payment server 66 sends a message to the recipient client device 63, prompting the recipient client device 63 (or the receiver) to register an account with the payment server 66. The message can also include instruction information used to guide the receiver to register an account with the payment server 66. After the receiver registers an account with the payment server 66, process proceeds with steps S627-S631 as described below.

Alternatively to S626, at S627, if the payment server 66 determines that the recipient client device 63 (or the receiver) has not register any account with the payment server 66, then the payment server 66 retrieves account information associated with the recipient client device 63 (or the receiver). Subsequently, at S628, the payment server 66 sends an authentication request to the recipient client device 63. Such an authentication request is to verify that the request to withdraw money is indeed sent from the recipient client device 63 (or sent by the receiver).

At S629, in response to the authentication request, the recipient client device 63 sends an authentication confirmation to the payment server 66. Correspondingly, the payment server 66 receives the authentication confirmation. Such an authentication confirmation includes authentication information provided by the receiver. For example, the recipient client device 63 presents information of the transaction (e.g., the amount of money requested to be withdrawn) to the receiver. The receiver then verifies the displayed information by, for example, clicking a “confirm” button displayed at the recipient client device 63. As a result, the recipient client device 63 generates and sends an authentication confirmation to the payment server 66.

At S630, the payment server 66 verifies the authentication information included in the received authentication confirmation. If the payment server 66 determines, based on the authentication information included in the received authentication confirmation, that the request to withdraw is a genuine request to withdraw from the receiver, then at S631, the payment server 66 transfers the corresponding amount of money to the account associated with the recipient client device 63 in accordance with the request to withdraw. That is, the payment server 66 completes the transaction by transferring the requested amount of money to the account that the receiver registers with the payment server 66.

Otherwise, although not shown in FIG. 6, if the payment server 66 determines, based on the authentication information included in the received authentication confirmation, that the request to withdraw is a not a genuine request to withdraw from the receiver, then the payment server rejects the request to withdraw and makes no transfer of money to any account associated with the recipient client device 63 (not shown in FIG. 6).

Additionally, in some embodiments, the payment server 66 can make a transaction in accordance with a request to withdraw received from the recipient client device 63 without further authenticating the receiver (or the recipient client device 63). In such embodiments, one or more operations from the operations described above with respect to the steps S628-S631 can be omitted.

FIG. 7 is a block diagram illustrating components of a sender client device 700 in accordance with some embodiments. FIG. 8 is a block diagram illustrating components of a server device 800 in accordance with some embodiments. FIG. 9 is a block diagram illustrating components of a recipient client device 900 in accordance with some embodiments. The sender client device 700 can be structurally and functionally similar to the sender client devices shown and/or described above with respect to FIGS. 1-6. The server device 800 can be structurally and functionally similar to the server devices shown and/or described above with respect to FIGS. 1-6. The recipient client device 900 can be structurally and functionally similar to the recipient client devices shown and/or described above with respect to FIGS. 1-6.

As shown in FIGS. 7-9, the sender client device 700 includes a communication module 710, a generation module 720 and a presentation module 730; the server device 800 includes a define module 810 and a distribution module 820; and the recipient client device 900 includes a receive module 910 and an interaction module 920. In some embodiments, each module included in the sender client device 700, the server device 800 and the recipient client device 900 can be a hardware-based module (e.g., a digital signal processor (DSP), a field programmable gate array (FPGA), an application-specific integrated circuit (ASIC), etc.), a software-based module (e.g., a module of computer code executed at a processor, a set of processor-readable instructions executed at a processor, etc.), or a combination of hardware and software modules. Instructions or code of each module can be stored in a memory (not shown in FIGS. 7-9) of the corresponding device and executed at a processor (e.g., a CPU, not shown in FIGS. 7-9) of the corresponding device.

The modules of the sender client device 700 (including the communication module 710, the generation module 720 and the presentation module 730) can be configured to collectively perform the method 200 in FIG. 2. The modules of the server device 800 (including the define module 810 and the distribution module 820) can be configured to collectively perform the method 300 in FIG. 3. The modules of the recipient client device 900 (including the receive module 910 and the interaction module 920) can be configured to collectively perform the method 400 in FIG. 4. Moreover, the modules of the sender client device 700, the server device 800 and the recipient client device 900 can be configured to collectively perform the methods 500 and 600 in FIGS. 5A and 6.

For the sender client device 700, the communication module 710 is configured to, among other functions, interact with a server device (e.g., the server device 52 in FIG. 5A, the server device 62 in FIG. 6) such that the server device defines a group of at least two virtual item packages, where each virtual item package from the group of virtual item packages contains a nonzero amount of virtual items. In some embodiments, for example, the communication module 710 is configured to perform operations of the steps S501-S505 of the method 500 shown and described above with respect to FIG. 5.

The generation module 720 is configured to, among other functions, generate a receiving link associated with distributing virtual items. Such a receiving link can be used by one or more targeted recipient client devices (e.g., the recipient client device 53 in FIG. 5A, the recipient client device 63 in FIG. 6) to receive virtual item packages from the group of virtual item packages. In some embodiments, for example, the generation module 720 is configured to perform operations of the steps S510-S511 of the method 500 shown and described above with respect to FIG. 5.

The presentation module 730 is configured to, among other functions, send the receiving link generated at the generation module 720 to the one or more targeted recipient client devices such that those targeted recipient client devices can interact with the server device to receive the virtual item packages from the group of virtual item packages. In some embodiments, for example, the presentation module 730 is configured to perform operations of the steps S512-S513 of the method 500 shown and described above with respect to FIG. 5.

For the server device 800, the define module 810 is configured to, among other functions, interact with a sender client device (e.g., the sender client device 51 in FIG. 5A, the sender client device 61 in FIG. 6) to define a group of at least two virtual item packages, where each virtual item package from the group of virtual item packages contains a nonzero amount of virtual items. In some embodiments, for example, the define module 810 is configured to perform operations of the steps S501-S502, S505-S510 and S513-S514 of the method 500 shown and described above with respect to FIG. 5.

The distribution module 820 is configured to, among other functions, interact with one or more targeted recipient client devices (e.g., the recipient client device 53 in FIG. 5A, the recipient client device 63 in FIG. 6) to distribute the virtual item packages defined at the define module 810 to the targeted recipient client devices. In some embodiments, for example, the distribution module 820 is configured to perform operations of the steps S516-S522 of the method 500 shown and described above with respect to FIG. 5.

For the recipient client device 900, the receive module 910 is configured to, among other functions, receive a receiving link from a sender client device (e.g., the sender client device 51 in FIG. 5A, the sender client device 61 in FIG. 6). The receiving link is used to receive virtual item packages from a server device (e.g., the server device 52 in FIG. 5A, the server device 62 in FIG. 6). In some embodiments, for example, the receive module 910 is configured to perform operations of the steps S512 and S515 of the method 500 shown and described above with respect to FIG. 5.

The interaction module 920 is configured to, among other functions, interact with the server device to receive virtual item packages. In some embodiments, for example, the interaction module 920 is configured to perform operations of the steps S516, S518-S519 and S522 of the method 500 shown and described above with respect to FIG. 5.

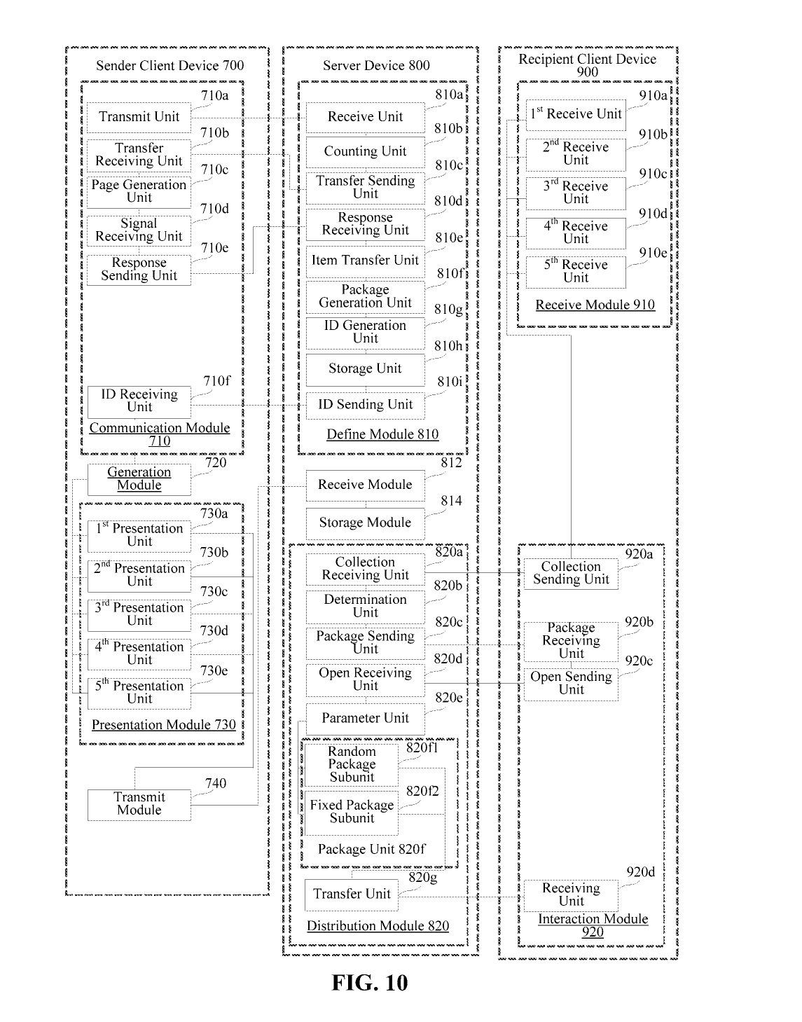

FIG. 10 is a block diagram illustrating components of the sender client device 700, the server device 800 and the recipient client device 900 of FIGS. 7-9. Particularly, the sender client device 700, the server device 800 and the recipient client device 900 are operatively coupled to and can communicate with each other (e.g., via one or more networks similar to the networks 13, 15 shown and described above with respect to FIG. 1). In some embodiments, although not shown in FIGS. 7-10, a sender client device, a server device or a recipient client device can have different modules, units, subunits from those shown in FIG. 10. In such embodiments, the modules, units and subunits in a sender client device, a server device or a recipient client device can be configured in an arrangement different from that shown in FIG. 10. Furthermore, each module, unit, subunit in a sender client device, a server device or a recipient client device can perform a portion of the function associated with a module, unit, subunit, or functions of more than one module, unit, subunit as shown and described with respect to FIG. 10.

As shown in FIG. 10, each module of the sender client device 700, the server device 800 and the recipient client device 900 includes multiple units (or submodules). In some embodiments, each of such units (or submodules) can be a hardware-based module (e.g., a DSP, a FPGA, an ASIC, etc.), a software-based module (e.g., a module of computer code executed at a processor, a set of processor-readable instructions executed at a processor, etc.), or a combination of hardware and software modules. Instructions or code of each unit (or submodule) can be stored in a memory (not shown in FIG. 10) of the corresponding device and executed at a processor (e.g., a CPU, not shown in FIG. 10) of the corresponding device.

In operation, a transmit unit 710a in the communication module 710 of the sender client device 700 is configured to send a request for distributing virtual items to the server device 800 (e.g., at the step S501 of the method 500 in FIG. 5A). Such a request for distributing virtual items includes parameters associated with the requested distribution of virtual items. Correspondingly, a receive unit 810a in the define module 810 of the server device 800 is configured to receive the request for distributing virtual items from the transmit unit 710a.

A counting unit 810b in the define module 810 is configured to determine a total amount of virtual items to be distributed based on the request for distributing virtual items received at the receive unit 810a. Specifically, the counting unit 810b can calculate the total amount of requested virtual items based on the parameters associated with the distribution that are included in the request for distributing virtual items.

A transfer sending unit 810c in the define module 810 of the server device 800 is configured to send a distribution confirmation request to the sender client device 700 (e.g., at the step S502 of the method 500 in FIG. 5A). Such a distribution confirmation request can include the total amount of requested virtual items that is determined at the counting unit 810b. Correspondingly, a transfer receiving unit 710b in the communication module 710 of the sender client device 700 is configured to receive the distribution confirmation request from the transfer sending unit 810c.

A page generation unit 710c in the communication module 710 of the sender client device 700 is configured to generate a distribution acknowledgement page (e.g., at the step S503 of the method 500 in FIG. 5A). The sender client device 700 is configured to display the distribution acknowledgement page generated at the page generation unit 710c to a user of the sender client device 700 (i.e., a sender). A signal receiving unit 710d in the communication module 710 of the sender client device 700 is configured to receive, from the sender, a distribution acknowledgement in response to the distribution acknowledgement page (e.g., at the step S504 of the method 500 in FIG. 5A).

A response sending unit 710e in the communication module 710 of the sender client device 700 is configured to send to the server device 800 a distribution confirmation signal that confirms the acknowledgement of the sender on performing the distribution of virtual items (e.g., at the step S505 of the method 500 in FIG. 5A). Correspondingly, a response receiving unit 810d in the define module 810 of the server device 800 is configured to receive the confirmation on the acknowledgement of the sender (via the distribution confirmation signal) from the response sending unit 710e.

An item transfer unit 810e in the define module 810 of the server device 800 is configured to transfer a corresponding amount of virtual items from an account associated with the sender client device 700 to an account associated with the server device 800 (e.g., at the step S506 of the method 500 in FIG. 5A). A package generation unit 810f in the define module 810 of the server device 800 is configured to define a group of virtual item packages according to the parameters associated with the distribution of virtual items (e.g., at the step S507 of the method 500 in FIG. 5A).

An identifier generation unit 810g in the define module 810 of the server device 800 is configured to generate an identifier for the defined group of virtual item packages (e.g., at the step S508 of the method 500 in FIG. 5A). A storage unit 810h in the define module 810 of the server device 800 is configured to store and associate the identifier of the group of virtual item packages with the parameters associated with the distribution of virtual items (e.g., at the step S509 of the method 500 in FIG. 5A). An identifier sending unit 810i in the define module 810 of the server device 800 is configured to send the identifier of the group of virtual item packages to the sender client device 700 (e.g., at the step S510 of the method 500 in FIG. 5A). Correspondingly, an identifier receiving unit 710f in the communication module 710 of the sender client device 700 is configured to receive the identifier of the group of virtual item packages from the identifier sending unit 810i.

As described above, the generation module 720 of the sender client device 700 is configured to generate a receiving link associated with distributing virtual items (e.g., at the step S511 of the method 500 in FIG. 5A). The receiving link generated at the generation module 720 includes the identifier of the group of virtual item packages that is received at the identifier receiving unit 710f.

As described above, the presentation module 730 of the sender client device 700 is configured to send the receiving link generated at the generation module 720 to the targeted recipient client device(s) (including the recipient client device 900) such that the targeted recipient client device(s) can interact with the server device 800 to receive the virtual item packages (e.g., at the step S512 of the method 500 in FIG. 5A). The presentation module 730 can implement various methods to send the receiving link to the targeted recipient client device(s).

Specifically, for example, a first presentation unit 730a in the presentation module 730 is configured to separately send an individual instant message containing the receiving link to each targeted recipient client device. A second presentation unit 730b in the presentation module 730 is configured to send a group instant message containing the receiving link to a group including the targeted recipient client device(s). A third presentation unit 730c in the presentation module 730 is configured to post a message containing the receiving link at a social media website (e.g., Facebook) that is accessible to each targeted recipient client device. A fourth presentation unit 730d in the presentation module 730 is configured to post a message containing the receiving link at a blogging website (e.g., Twitter) that is accessible to each targeted recipient client device. A fifth presentation unit 730e in the presentation module 730 is configured to display a barcode containing the receiving link that can be scanned by each targeted recipient client device.

As described above, the receive module 910 of the recipient client device 900 is configured to receive the receiving link from the sender client device 700. Corresponding to the various methods implemented at the presentation module 730 of the sender client device 700 to send the receiving link, the receive module 910 of the recipient client device 900 is configured to receive the receiving link in those respective methods.

Specifically, for example, a first receive unit 910a in the receive module 910 is configured to receive an individual instant message containing the receiving link from the first presentation unit 730a in the presentation module 730. Such an individual instant message may be sent by the first presentation unit 730a solely to the recipient client device 900 without being sent to any other recipient client device. A second receive unit 910b in the receive module 910 is configured to receive a group instant message containing the receiving link from the second presentation unit 730b in the presentation module 730. Such a group instant message is sent by the second presentation unit 730b to a group of recipient client devices including the recipient client device 900. A third receive unit 910c in the receive module 910 is configured to access a message containing the receiving link that is posted at a social media website by the third presentation unit 730c in the presentation module 730. A fourth receive unit 910d in the receive module 910 is configured to access a message containing the receiving link that is posted at a blogging website by the fourth presentation unit 730d in the presentation module 730. A fifth receive unit 910e in the receive module 910 is configured to obtain the receiving link by scanning a barcode containing the receiving link that is displayed by the fifth presentation unit 730e in the presentation module 730.

Additionally, a transmit module 740 of the sender client device 700 is configured to send information associated with the receiving link to the server device 800 (e.g., at the step S513 of the method 500 in FIG. 5A). The information associated with the receiving link includes, for example, the identifier of the group of virtual item packages, an identifier of the sender client device 700, an identifier of each targeted recipient client device (including the recipient client device 900), and/or the like. Correspondingly, a receive module 812 of the server device 800 receives the information associated with the receiving link from the transmit module 740. A storage module 814 of the server device 800 is configured to store and associate the identifier of the sender client device 700 and the identifier(s) of the targeted of recipient client device(s) with the identifier of the group of virtual item packages (e.g., at the step S514 of the method 500 in FIG. 5A).

As described above, the distribution module 820 of the sender device 800 is configured to interact with the interaction module 920 of the recipient client device 900 to distribute the virtual item packages defined at the define module 810 to the recipient client device 900. Specifically, for example, a collection sending unit 920a in the interaction module 920 is configured to send, to the server device 800, a request to receive virtual items (e.g., at the step S516 of the method 500 in FIG. 5A). The request to receive virtual items can be generated at the recipient client device 900 in response to the receive module 910 of the recipient client device 900 receiving the receiving link from the presentation module 730 of the sender client device 700 (e.g., at the step S515 of the method 500 in FIG. 5A). In some embodiments, the request to receive virtual items can include information associated with the distribution of virtual items such as, for example, the identifier of the recipient client device 900, the identifier of the group of virtual item packages, and/or any other suitable information.

Correspondingly, a collection receiving unit 820a in the distribution module 820 is configured to receive the request to receive virtual items from the collection sending unit 920a. A determination unit 820b in the distribution module 820 is configured to determine if the recipient client device 900 (or a receiver operating the recipient client device 900) satisfies a predefined condition for receiving virtual items (e.g., at the step S517 of the method 500 in FIG. 5A). As described above, such a predefined condition can be a combination of multiple conditions such as, for example, the identifier of the recipient client device 900 (or identifier of the receiver) being associated with the identifier of the group of virtual item packages and such an association being stored in the server device 800; the number of remaining virtual item package(s) from the group of virtual item packages being greater than zero; the recipient client device 900 (or the receiver) having not received any virtual item package from the group of virtual item packages, and/or the like.

If the determination unit 820b determines that the recipient client device 900 (or the receiver) satisfies the predefined condition for receiving virtual items, a package sending unit 820c in the distribution module 820 is configured to send a virtual item package from the group of virtual item packages to the recipient client device 900 (e.g., at the step S518 of the method 500 in FIG. 5A). As described above, the package sending unit 820c can select the virtual item package from the group of virtual item packages in any suitable method. Correspondingly, a package receiving unit 920b in the interaction module 920 of the recipient client device 900 is configured to receive the virtual item package from the package sending unit 820c.

In response to receiving the virtual item package, an open sending unit 920c in the interaction module 920 of the recipient client device 900 is configured to send, to the server device 800, a request to open the received virtual item package (e.g., at the step S519 of the method 500 in FIG. 5A). In some embodiments, the request to open can include the identifier of the group of virtual item packages and/or the identifier of the recipient client device 900. Correspondingly, an open receiving unit 820d in the distribution module 820 of the server device 800 is configured to receive the request to open from the open sending unit 920c.

Subsequently, a parameter unit 820e in the distribution module 820 of the server device 800 is configured to retrieve parameters associated with the distribution of virtual items (e.g., at the step S520 of the method 500 in FIG. 5A). Specifically, the parameter unit 820e can retrieve the parameters based on the association between the identifier of the group of virtual item packages and the parameters of the distribution, which is stored at the server device 800 by the storage unit 810h.

A package unit 820f in the distribution module 820 of the server device 800 is configured to determine the amount of virtual items in the virtual item package based on the parameters of the distribution retrieved by the parameter unit 820e (e.g., at the step S521 of the method 500 in FIG. 5A). The package unit 820f can determine the amount of virtual items in various means. Specifically, for example, if the parameters of the distribution include a total amount of virtual items to be distributed and a total number of virtual item packages from the group of virtual item packages, then a random package subunit 820f1 in the package unit 820f can randomly determine, based on the remaining total amount of virtual items and the remaining number of virtual item packages, the amount of virtual items included in the virtual item package sent to the recipient client device 900. For another example, if the parameters of the distribution include a fixed amount of virtual items to be included in each virtual item package and a total number of virtual item packages from the group of virtual item packages, then a fixed package subunit 820f2 in the package unit 820f can determine that the amount of virtual items included in the virtual item package sent to the recipient client device 900 is that fixed amount.

Next, a transfer unit 820g in the distribution module 820 of the server device 800 is configured to transfer a corresponding amount of virtual items from the account associated with the server device 800 to an account associated with the recipient client device 900 (or an account associated with the receiver) (e.g., at the step S522 of the method 500 in FIG. 5A). Correspondingly, a receiving unit 920d in the interaction module 920 of the recipient client device 900 is configured to receive the virtual items transferred from the transfer unit 820g.

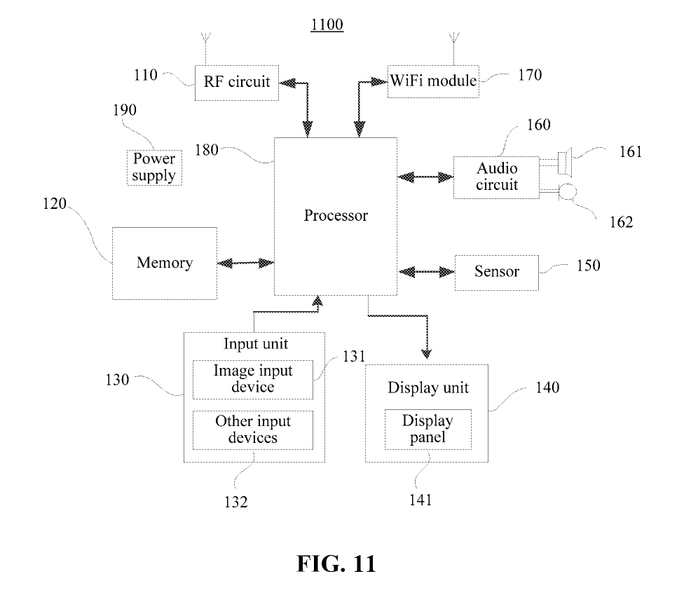

FIG. 11 is a block diagram illustrating components of a client device 1100 in accordance with some embodiments. The client device 1100 can be a sender client device, a recipient client device, or a client device configured to perform both functions of sending and receiving virtual items. The client device 1100 can be structurally and functionally similar to the client devices shown and described above with respect to FIGS. 1-10. The client device 1100 can be operatively coupled to (e.g., via one or more networks similar to the networks 13, 15 in FIG. 1) and communicate with a server device (e.g., the server device 14 in FIG. 1) and one or more other client devices (e.g., the client devices 12, 16 in FIG. 1).

As shown in FIG. 11, the client device 1100 includes a processor 180, a memory 120, an input unit 130, a display unit 140, a sensor 150, an audio circuit 160, a Wi-Fi (Wireless Fidelity) module 170, a radio frequency (RF) circuit 110 and a power supply 190. In some embodiments, the client device 1100 can include more or less devices, components and/or modules than those shown in FIG. 11. One skilled in the art understands that the structure of the client device 1100 shown in FIG. 11 does not constitute a limitation for the client device 1100, and may include more or less components than those illustrated in FIG. 11. Furthermore, the components of the client device 1100 (shown or not shown in FIG. 11) can be combined and/or arranged in different ways other than that shown in FIG. 11. In some embodiments, the components and modules of the client device 1100 can be configured to collectively perform the methods 200, 400 and/or the corresponding client-side portions of the methods 500, 600 shown and described above with respect to FIGS. 2, 4, 5A and 6.

The RF circuit 110 is configured to send and receive data, and in particular, to send uplink to data to and/or receive downlink data from a base station (e.g., a server device). The RF circuit 110 is configured to send the received data to the processor 180 for further processing. The RF circuit 110 can include, for example, one more antenna, amplifier, tuner, oscillator, subscriber identity module (SIM) card, transceiver, coupler, low noise amplifier (LNA), duplexer, etc. The RF circuit 110 is configured to wirelessly communicate with other network or device using any suitable wireless communication protocol such as, for example, GSM, GPRS, CDMA, WCDMA, LTE, etc.

The memory 120 is configured to store software programs and/or modules. The processor 180 can execute various applications and data processing functions included in the software programs and/or modules stored in the memory 120. The memory 120 includes, for example, a program storage area and a data storage area. The program storage area is configured to store, for example, an operating system and application programs. The data storage area is configured to store data received and/or generated during the use of the client device 1100 (e.g., identifier of a group of virtual item packages, identifiers of targeted recipient client devices, etc.). The memory 120 can include one or more high-speed random-access memory (RAM), non-volatile memory such as a disk storage device and a flash memory device, and/or other volatile solid state memory devices. In some embodiments, the memory 120 also includes a memory controller configured to provide the processor 180 and the input unit 130 with access to the memory 120.

The input unit 130 is configured to receive input data and signals (e.g., a distribution acknowledgement from a user) and also generate signals caused by operations and manipulations of input devices such as, for example, a user's finger, a touch pen, a keyboard, a mouse, etc. Specifically, the input unit 130 includes an image input device 131 (e.g., a touch screen, a touchpad) and other input devices 132. The image input device 131 is configured to collect touch operations on or near the image input device 131 that are performed by a user of the client device 1100, such as operations performed by the user using a finger, stylus, touch pen, or any other suitable object or attachment on or near a touch-sensitive surface of the image input device 131. In some embodiments, the image input device 131 can optionally include a touch detection apparatus and a touch controller. The touch detection apparatus can detect the direction of the touch operation and signals generated by the touch operation, and then transmit the signals to the touch controller. The touch controller can receive the signals from the touch detection apparatus, convert the signals into contact coordinate data, and then send the contact coordinate data to the processor 180. The touch controller can also receive and execute commands received from the processor 180. The image input device 131 can be implemented using various types of technologies such as, for example, resistive touch screen, capacitive touch screen, infrared ray touch screen, surface acoustic wave (SAW) touch screen, etc. The other input devices 132 can include, for example, a physical keyboard, a function key (such as a volume control key, a switch key, etc.), a trackball, a mouse, a joystick, etc.

The display unit 140 is configured to display information (e.g., a receiving link, a distribution acknowledgement page, etc.) entered by a user and/or received from another device (e.g., a server device or another client device) on various graphical user interfaces (GUIs) of the client device 1100. The GUIs can include, for example, graph, text, icon, video, and/or any combination of them. The display unit 140 includes a display panel 141, which can be, for example, a LCD, a LED, organic light-emitting diode (OLED) display, etc. Furthermore, the image input device 131 can cover the display panel 141. After a touch operation on or near the image input device 131 is detected, the image input device 131 transmits information of the touch operation to the processor 180, where the type and/or other information of the touch operation are determined. The processor 180 sends visual information to the display panel 141 based on the determined type of the touch operation. The visual information is then displayed on the display panel 141. Although shown in FIG. 11 as two separate components for the input and output functions respectively, in other embodiments, the image input device 131 and the display panel 141 can be integrated into one component for realization of the input and output functions.

The client device 1100 includes at least one sensor 150 such as, for example, a light sensor, a motion sensor, and/or other types of sensors. A light sensor can be, for example, an ambient light sensor or a proximity sensor. The ambient light sensor is configured to adjust the brightness of the display panel 141 according to the light intensity received at the ambient light sensor. The proximity sensor is configured to turn off the display panel 141 and/or backlight when, for example, the client device 1100 moves near a user's ear. A motion sensor can be, for example, an acceleration transducer that can measure acceleration at each direction (e.g., 3-axis directions), measure the magnitude and direction of gravity when stationary, be used in applications for recognition of the posture of the client device 1100 (e.g., horizontal and vertical screen switching, games, magnetometer posture calibration), be used in applications related to vibration recognition (e.g., pedometer, percussion), and/or the like. Additionally, although not shown in FIG. 11, the client device 1100 can also include other sensory devices such as, for example, a gyroscope, a barometer, a hygrometer, a thermometer, an infrared sensor, and/or the like.

The audio circuit 160, the speaker 161 and the microphone 162 collectively provide an audio interface between the user and the client device 1100. The audio circuit 160 transmits an electric signal converted from audio data to the speaker 161, where the electric signal is converted and output as an acoustical signal by the speaker 161. The microphone 162 converts a collected acoustical signal into an electric signal, which is then sent to and converted to audio data by the audio circuit 160. The audio data is sent to the processor 180 for further processing, and then sent to another terminal device through the RF circuit 110 or stored in the memory 120 for further processing. The audio circuit 160 can also include an earplug jack to enable communication between a peripheral headset and the client device 1100. In some embodiments, a speech message spoken by the user can be received through the microphone 162 and the audio circuit 160. Similarly, a speech message received from the server device can be played using the speaker 161 and the audio circuit 160.

The Wi-Fi module 170 is configured to enable Wi-Fi communication between the client device 1100 and other devices or network. For example, the Wi-Fi module 170 provides the user with a wireless access to broadband Internet. As a result, the user can use the Wi-Fi connection to, for example, send and receive E-mails, browse web pages, access streaming media, and so on. Although shown in FIG. 11 as including the Wi-Fi module 170, in some other embodiments, a client device can operate without such a Wi-Fi module or the Wi-Fi functionality.

The processor 180 functions as a control center of the client device 1100. The processor 180 is configured to operatively connect each component of the client device 1100 using various interfaces and circuits. The processor 180 is configured to execute the various functions of the client device 1100 and to perform data processing by operating and/or executing the software programs and/or modules stored in the memory 120 and using the data stored in the memory 120. In some embodiments, the processor 180 can include one or more processing cores. In some embodiments, an application processor and a modem processor can be integrated at the processor 180. The application processor is configured to monitor and control the operating system, user interfaces, application programs, and so on. The modem processor is configured to control wireless communication.

The power supply 190 is used to provide power for the various components of the client device 1100. The power supply 190 can be, for example, a battery. The power supply 190 can be operatively coupled to the processor 180 via a power management system that controls charging, discharging, power consumption, and/or other functions related to power management. In some embodiments, the power supply 190 can include one or more DC and/or AC power source, recharging system, power failure detection circuit, power converter or inverter, power supply status indicator, and/or the like.

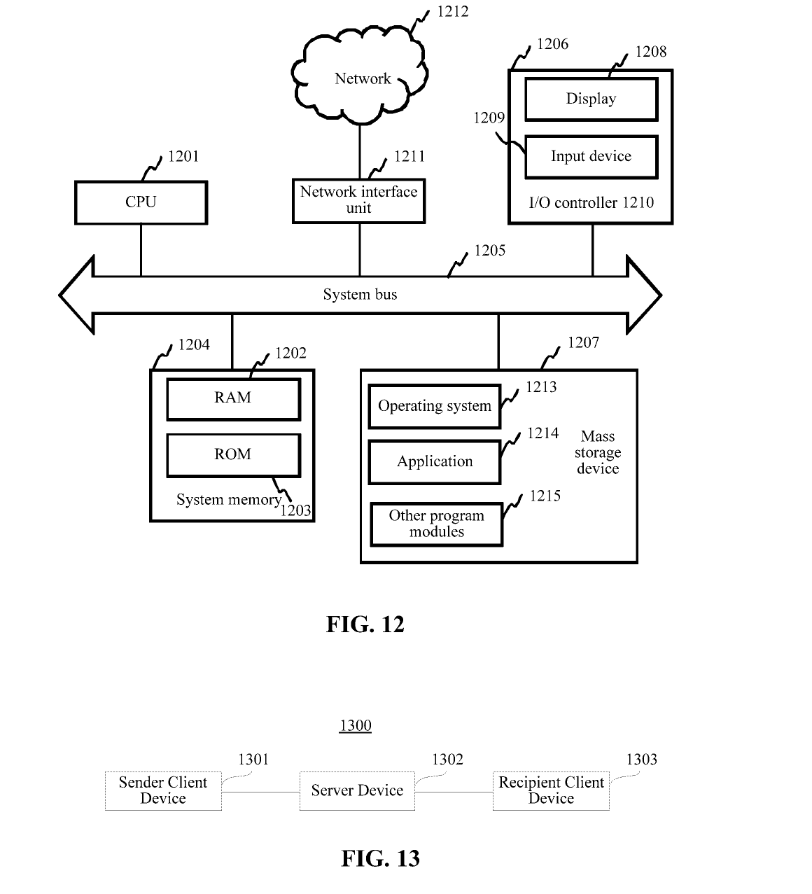

FIG. 12 is a block diagram illustrating components of a server device 1200 in accordance with some embodiments. The server device 1200 can be structurally and functionally similar to the server devices shown and described above with respect to FIGS. 1-10. The server device 1200 can be operatively coupled to (e.g., via a network 1212) and communicate with a group of client devices (e.g., the client devices in FIGS. 1-11). As shown in FIG. 12, the server device 1200 includes a CPU 1201, a system memory 1204, a system bus 1205, a network interface unit 1211, a mass storage device 1207, and an input/output controller 1210. In some embodiments, the server device 1200 can include more or less devices, components and/or modules than those shown in FIG. 12. In some embodiments, the devices, components and modules of the server device 1200 can be configured to collectively perform the method 300 and/or the corresponding server-side portions of the methods 500, 600 shown and described above with respect to FIGS. 3, 5A and 6.

The CPU 1201 can be any processing device capable of performing the server-side portions of the methods for distributing virtual items described herein. The CPU 1201 can be implemented as, for example, a DSP, a FPGA, a ASIC, and/or the like. The CPU 1201 can be configured to control the operations of other components and/or modules of the server device 1200. For example, the CPU 1201 can be configured to control operations of the network interface unit 1211. For another example, the CPU 1201 can be configured to execute instructions or code stored in a software program or module (e.g., an operating system 1213, an application 1214, other program modules 1215) within the mass storage device 1207. In some embodiments, the CPU 1201 can include one or more processing cores.

The system bus 1205 is configured to implement connections and communication among the other components of the server device 1200. The network interface unit 1211 is configured to provide and control network interfaces of the server device 1200 that are used to interact with other network devices (e.g., client devices). The network interface unit 1211 can include, for example, a standard wired interface and a standard wireless interface (e.g., a Wi-Fi interface). In some embodiments, the network interface unit 1211 is used for connecting one or more client devices and performing data communication with the one or more client devices. In some embodiments, as shown in FIG. 12, the network interface unit 1211 is configured to connect the server device 1200 to the network 1212, which can be similar to the networks 13, 15 shown and described above with respect to FIG. 1. In some embodiments, operations of network interface unit 1211 are controlled by instructions or code stored in the operating system 1213 in the mass storage device 1207.

In some embodiments, the server device 1200 can also be run in a remote computer connected via a network such as, for example, the Internet. For example, the server device 1200 can be connected to the network 1212, and/or any type of remote computer system, through the network interface unit 1211.

The input/output controller 1210 is configured to provide and control input/output interfaces that are used to interact with client devices and/or an operator of the server device 1200. Such input/output interfaces can include, for example, a display 1208 (e.g., a monitor, a screen), an input device 1209 (e.g., a keyboard, a mouse), and other input/output devices (e.g., a printer, a speaker, a light, an alarm, etc.). In some embodiments, operations of the input/output controller 1210 are controlled by instructions or code stored in the operating system 1213 in the mass storage device 1207.

The system memory 1204 can include, for example, a RAM 1202 (e.g., a DRAM, a SRAM, a DDR RAM, etc.), a read-only memory (ROM) 1203, a non-volatile memory such as one or more magnetic disk storage devices, optical disk storage devices, flash memory devices, or other non-volatile solid state storage devices. In some embodiments, the system memory 1204 can include one or more storage devices (e.g., a removable memory) remotely located from other components of the server device 1200.

The mass storage device 1207 can be structurally similar to the system memory 1204. The mass storage device 1207 can be any type of memory device (e.g., flash memory device, removable memory device, magnetic disk storage device, optical disk storage device, etc.) configured to store modules, programs, applications of the server device 1200. In some embodiments, the mass storage device 1207 can include computer readable mediums such as, for example, a hard disk or CD-ROM driver. As shown in FIG. 12, the mass storage device 1207 includes at least the operating system 1213, the application 1214 and other program modules 1215.

Without loss of generality, the mentioned computer readable medium can include computer memory medium and communication medium. The computer memory medium includes volatile and non-volatile, mobile and immobile mediums realized by any method or technology which is configured to store information such as computer readable instruction, data structure, program module or other data. The computer memory medium includes RAM, ROM, EPROM, EEPROM, flash memory or other solid-state storage technologies, CD-ROM, DVD or other optical storages, cassette, magnetic tape, magnetic disk memory or other magnetic memory devices. In some embodiments, the system memory 1204 and the mass storage device 1207 can be collectively referred to as memory of the server device 1200.

In some embodiments, each component, program, application or module included in the mass storage device 1207 can be a hardware-based module (e.g., a DSP, a FPGA, a ASIC), a software-based module (e.g., a module of computer code executed at a processor, a set of processor-readable instructions executed at a processor), or a combination of hardware and software modules. Instructions or code of each component, program, application or module can be stored in the mass storage device 1207 and executed at the CPU 1201. In some embodiments, the mass storage device 1207 can include more or less components, programs, applications or modules than those shown in FIG. 12.

In some embodiments, the server device 1200 is configured to perform the method 300 and the corresponding server-side portions of the methods 500, 600 shown and described above with respect to FIGS. 3, 5A and 6. In such embodiments, the application 1214 can be a server-side portion of an application associated with distributing virtual items from a sender client device to a set of recipient client devices. Thus, the application 1214, when executed by the CPU 1201, is configured to perform at least a portion (the server-side portion) of the above-described methods to distribute virtual items, as shown and described above with respect to FIGS. 3, 5A and 6.

FIG. 13 is a schematic diagram illustrating a system 1300 including a sender client device 1301, a server device 1302 and a recipient client device 1303 in accordance with some embodiments. The sender client device 1301 and the recipient client device 1303 are structurally and functionally similar to the client devices shown and described above with respect to FIGS. 1, 5A-7 and 9-11. The server device 1302 is structurally and functionally similar to the server devices shown and described above with respect to FIGS. 1, 5A, 6, 10 and 12. As shown in FIG. 13, the server device 1302 is operatively coupled to and communicates with the sender client device 1301 and the recipient client device 1303.

Specifically, the sender client device 1301 is configured to perform the method 200 and the sender-side portions of the methods 500, 600 as shown and described above with respect to FIGS. 2, 5A and 6. The recipient client device 1303 is configured to perform the method 400 and the recipient-side portions of the methods 500, 600 as shown and described above with respect to FIGS. 4, 5A and 6. The server device 1302 is configured to perform the method 300 and the server-side portions of the methods 500, 600 as shown and described above with respect to FIGS. 3, 5A and 6. Collectively, the system 1300 is configured to perform the methods 500 and 600 as shown and described above with respect to FIGS. 5A and 6.

The foregoing description, for purpose of explanation, has been described with reference to specific embodiments. However, the illustrative discussions above are not intended to be exhaustive or to limit the present application to the precise forms disclosed. Many modifications and variations are possible in view of the above teachings. The embodiments were chosen and described in order to best explain the principles of the present application and its practical applications, to thereby enable others skilled in the art to best utilize the present application and various embodiments with various modifications as are suited to the particular use contemplated.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the present application herein is for the purpose of describing particular embodiments only and is not intended to be limiting of the present application. As used in the description of the present application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

What is claimed is:

1. A method of distributing virtual items at a server device, comprising:
at a computer system having one or more processors and memory for storing programs to be executed by the one or more processors:
receiving, from a sender client device, a request for distributing virtual items to a set of recipient client devices, the request including parameters associated with the distribution of virtual items;
in response to the request for distributing virtual items, transferring a total amount of virtual items to be distributed from an account associated with the sender client device to an account associated with the server device;
defining, based on the parameters associated with the distribution of virtual items, a plurality of virtual item packages, each virtual item package from the plurality of virtual item packages including at least one virtual item, the total amount of virtual items included in the plurality of virtual item packages corresponding to the total amount of virtual items transferred from the account associated with the sender client device to the account associated with the server device;
sending information of the plurality of virtual item packages to the sender client device whereby the sender client device generates a link associated with the distribution of virtual items and sends the link to the set of recipient client devices;
receiving, from a recipient client device from the set of recipient client devices, a request to receive virtual items; and
in response to the request to receive virtual items, transferring a virtual item package from the plurality of virtual item package from the account associated with the server device to an account associated with the recipient client device.

2. The method of claim 1, wherein the parameters associated with the distribution of virtual items include at least two of (1) the total amount of virtual items to be distributed, (2) a total number of virtual item packages, and (3) an amount of virtual items associated with each virtual item package.

3. The method of claim 1, further comprising, before sending information of the plurality of virtual item packages to the sender client device, generating an identifier for the plurality of virtual item packages; the sending information of the plurality of virtual item packages including sending the identifier of the plurality of virtual item packages to the sender client device.

4. The method of claim 1, wherein a user of each recipient client device from the set of recipient client devices has a social relationship with a user of the sender client device.

5. The method of claim 1, further comprising, after receiving the request to receive virtual items and before transferring the virtual item package in response to the request to receive virtual items, determining if the recipient client device satisfies a predefined condition for receiving the virtual items.

6. The method of claim 5, wherein the predefined condition for receiving the virtual items includes that a user of the recipient client device has a predefined social relationship with a user of the sender client device.

7. The method of claim 1, wherein the receiving the request for distributing virtual items includes receiving identifiers of each recipient client device from the set of recipient client devices such that the server device stores and associates the identifiers of the set of recipient client devices with the plurality of virtual item packages.

8. The method of claim 1, wherein the defining the plurality of virtual item packages includes randomly assigning virtual items to each virtual item package from the plurality of virtual item packages in accordance with the parameters associated with the distribution of virtual items.

9. The method of claim 1, wherein the transferring a virtual item package in response to the request to receive virtual items includes randomly selecting the virtual item package from a group of virtual item packages that have not been transferred from the account associated with the server device to an account associated with a recipient client device from the set of recipient client devices.

10. A server device configured to distribute virtual items, comprising:
one or more processors; and
memory storing one or more programs to be executed by the one or more processors, the one or more programs comprising instructions for:
receiving, from a sender client device, a request for distributing virtual items to a set of recipient client devices, the request including parameters associated with the distribution of virtual items;
in response to the request for distributing virtual items, transferring a total amount of virtual items to be distributed from an account associated with the sender client device to an account associated with the server device;
defining, based on the parameters associated with the distribution of virtual items, a plurality of virtual item packages, each virtual item package from the plurality of virtual item packages including at least one virtual item, the total amount of virtual items included in the plurality of virtual item packages corresponding to the total amount of virtual items transferred from the account associated with the sender client device to the account associated with the server device;
sending information of the plurality of virtual item packages to the sender client device whereby the sender client device generates a link associated with the distribution of virtual items and sends the link to the set of recipient client devices;
receiving, from a recipient client device from the set of recipient client devices, a request to receive virtual items; and
in response to the request to receive virtual items, transferring a virtual item package from the plurality of virtual item package from the account associated with the server device to an account associated with the recipient client device.

11. The server device of claim 10, wherein the parameters associated with the distribution of virtual items include at least two of (1) the total amount of virtual items to be distributed, (2) a total number of virtual item packages, and (3) an amount of virtual items associated with each virtual item package.

12. The server device of claim 10, wherein a user of each recipient client device from the set of recipient client devices has a social relationship with a user of the sender client device.

13. The server device of claim 10, wherein the one or more programs further comprise instructions for: after receiving the request to receive virtual items and before transferring the virtual item package in response to the request to receive virtual items, determining if the recipient client device satisfies a predefined condition for receiving the virtual items.

14. The server device of claim 10, wherein the receiving the request for distributing virtual items includes receiving identifiers of each recipient client device from the set of recipient client devices such that the server device stores and associates the identifiers of the set of recipient client devices with the plurality of virtual item packages.

15. The server device of claim 10, wherein the defining the plurality of virtual item packages includes randomly assigning virtual items to each virtual item package from the plurality of virtual item packages in accordance with the parameters associated with the distribution of virtual items.

16. The server device of claim 10, wherein the transferring a virtual item package in response to the request to receive virtual items includes randomly selecting the virtual item package from a group of virtual item packages that have not been transferred from the account associated with the server device to an account associated with a recipient client device from the set of recipient client devices.

17. A non-transitory computer readable storage medium storing one or more programs, the one or more programs comprising instructions, which, when executed by one or more processors, cause the processors to perform operations comprising:
at a server device:
receiving, from a sender client device, a request for distributing virtual items to a set of recipient client devices, the request including parameters associated with the distribution of virtual items;
in response to the request for distributing virtual items, transferring a total amount of virtual items to be distributed from an account associated with the sender client device to an account associated with the server device;
defining, based on the parameters associated with the distribution of virtual items, a plurality of virtual item packages, each virtual item package from the plurality of virtual item packages including at least one virtual item, the total amount of virtual items included in the plurality of virtual item packages corresponding to the total amount of virtual items transferred from the account associated with the sender client device to the account associated with the server device;
sending information of the plurality of virtual item packages to the sender client device whereby the sender client device generates a link associated with the distribution of virtual items and sends the link to the set of recipient client devices;
receiving, from a recipient client device from the set of recipient client devices, a request to receive virtual items; and
in response to the request to receive virtual items, transferring a virtual item package from the plurality of virtual item package from the account associated with the server device to an account associated with the recipient client device.

18. The non-transitory computer readable storage medium of claim 17, wherein a user of each recipient client device from the set of recipient client devices has a social relationship with a user of the sender client device.

19. The non-transitory computer readable storage medium of claim 17, wherein the one or more programs further comprise instructions for: after receiving the request to receive virtual items and before transferring the virtual item package in response to the request to receive virtual items, determining if the recipient client device satisfies a predefined condition for receiving the virtual items.

20. The non-transitory computer readable storage medium of claim 17, wherein the receiving the request for distributing virtual items includes receiving identifiers of each recipient client device from the set of recipient client devices such that the server device stores and associates the identifiers of the set of recipient client devices with the plurality of virtual item packages.
